(19) United States
(12) Patent Application Publication
(10) Pub. No.: US 2017/0011373 A1
(43) Pub. Date: Jan. 12, 2017

(54) LOCATION BASED TRANSACTION TRACKING BASED ON DATA FROM DEVICES AT TRANSACTION LOCATION

(71) Applicant: PAYPAL, INC., San Jose, CA (US)

(72) Inventor: Michael Charles Todasco, San Jose, CA (US)

(21) Appl. No.: 14/792,043

(22) Filed: Jul. 6, 2015

(51) Int. Cl. G06Q 20/14; G06Q 20/40; G06Q 20/10

(52) U.S. Cl. CPC G06Q 20/14; G06Q 20/10; G06Q 20/405

(57) ABSTRACT

Systems and methods for tracking physical bills and providing alerts related to the tracking include receiving first cash transfer information that includes at least one first identifier associated with at least one first physical bill from the first payer device. The first cash transfer information is associated with the first payer account information in a non-transitory memory. Second cash transfer information is then received from a second device that is different than the first payer device. The second cash transfer information is determined to be associated with the first cash transfer information and, in response, a cash transaction association message is sent to at least one of the first payer device and the second device.

### BACKGROUND

Field of the Disclosure

The present disclosure generally relates to electronically tracking transactions, and more particularly to a transaction tracking system for electronically tracking transactions with either individuals or merchants based on data from devices at the transaction location.

Related Art

More and more consumers are conducting transactions, such as purchasing items and services, over electronic networks such as, for example, the Internet. Consumers routinely purchase products and services from merchants and individuals alike. The transactions may take place directly between a conventional or on-line merchant or retailer and the consumer, and payment may be made by using cash or entering credit card or other financial information. Transactions may also take place with the aid of an on-line or mobile payment service provider such as, for example, PayPal, Inc. of San Jose, Calif. Such payment service providers can make transactions easier and safer for the parties involved. Purchasing with the assistance of a payment service provider from the convenience of virtually anywhere using a mobile device is one main reason why on-line and mobile purchases are growing very quickly.

Some payment service providers provide online and mobile payment services for individuals and merchants, and those online and mobile payment services may include the tracking of transactions. Such tracking is relatively easy when transactions are conducted electronically (e.g., using a credit card, mobile payment applications, and/or other electronic transaction tracking systems known in the art). However, some transactions may be made by using cash, which can make the tracking of the transaction relatively difficult. For example, merchants may attempt to track cash transactions by creating cash transaction confirmations (e.g., receipts) and providing their customers with the cash transaction confirmations. However, such cash transaction tracking requires the customer and merchant to save receipts and manually enter information as part of the cash transaction tracking system, which adds additional steps to the transaction tracking, increases the complexity of the transaction tracking, and can introduce human error. Such difficulties in cash transaction tracking tends to prevent customers and merchants from tracking cash transactions, or providing for only the most minimal tracking of cash transactions.

Thus, there is a need for an improved cash transaction tracking system.

### BRIEF DESCRIPTION OF THE FIGURES

FIG. 1 is a flow chart illustrating an embodiment of a method for tracking cash transactions.

FIG. 2A is a schematic view illustrating an embodiment of a payer device being used by a payer in a cash transaction.

FIG. 2B is a first-person view illustrating an embodiment of an image that may be captured by the payer device during the cash transaction of FIG. 2A.

FIG. 2C is a schematic view illustrating an embodiment of a payer device.

FIG. 2D is a first-person view illustrating an embodiment of a payer device of FIG. 2C being used by a payer during a cash transaction.

FIG. 3 is a schematic view illustrating an embodiment of a cash transaction tracking system.

FIG. 4 is a schematic view illustrating an embodiment of a payer database in the cash transaction tracking system of FIG. 3.

FIG. 5 is a front view illustrating an embodiment of a payer device displaying a cash transaction confirmation screen regarding the cash transaction of FIG. 2A.

FIG. 6A is a schematic view illustrating an embodiment of a payer device being used by a payer during a cash transaction.

FIG. 6B is a first-person view illustrating an embodiment of an image that may be captured by the payer device of FIG. 6A during the cash transaction of FIG. 6A.

FIG. 7A is a schematic view illustrating an embodiment of a merchant device being used by a merchant during a cash transaction.

FIG. 7B is a first person view illustrating an embodiment of an image that may be captured by a payer device during the cash transaction of FIG. 7A.

FIG. 8A is a schematic view illustrating an embodiment of a payer database in the cash transaction system of FIG. 3.

FIG. 8B is a first person view illustrating an embodiment of the payer device of FIG. 6A displaying a duplicate payment warning screen with respect to the cash transaction of FIG. 6A.

FIG. 9A is a schematic view illustrating an embodiment of a merchant database in the cash transaction system of FIG. 3.

FIG. 9B is a front view illustrating an embodiment of a payer device displaying a merchant cash transaction confirmation screen with respect to the cash transaction of FIG. 7A.

FIG. 10 is a schematic view illustrating an embodiment of a networked system.

FIG. 11 is a perspective view illustrating an embodiment of a payer device.

FIG. 12 is a perspective view illustrating an embodiment of a payer device.

FIG. 13 is a schematic view illustrating an embodiment of a computer system.

FIG. 14 is a schematic view illustrating an embodiment of a system provider device.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides a system and method for tracking transactions at a location using data obtained from devices at the transaction location. Various payer devices may be used during cash transactions by payers, and may be configured to capture cash transfer information, including identifiers associated with the physical bills used in the cash transactions. Similarly, merchant devices may be used during cash transactions at a merchant physical location, and may be configured to capture cash transfer information, including identifiers associated with the physical bills used in the cash transactions. A system provider device receiving cash transfer information from payer devices and/or merchant devices may use that cash transfer information for various cash tracking functions. In some embodiments, the system provider device may use the cash transfer information to determine that a cash transaction associated with a first payer may be a duplicate cash payment of a previous cash transaction associated with a second payer, and a duplicate payment warning message may be sent to the payer device of the first payer used in the cash transaction. In some embodiments, the system provider device may determine that cash transfer information received from a payer device and cash transfer information received from a merchant device are associated with the same cash transaction, e.g., by using identifiers associated with the physical bills used in the cash transaction, and a merchant cash transaction confirmation message may be sent to the payer device and/or merchant device used in the cash transaction. However, these embodiments are meant to be merely exemplary, and one of skill in the art will recognize that a variety of modifications may be made to the cash transaction tracking system discussed below without departing from the scope of the present disclosure.

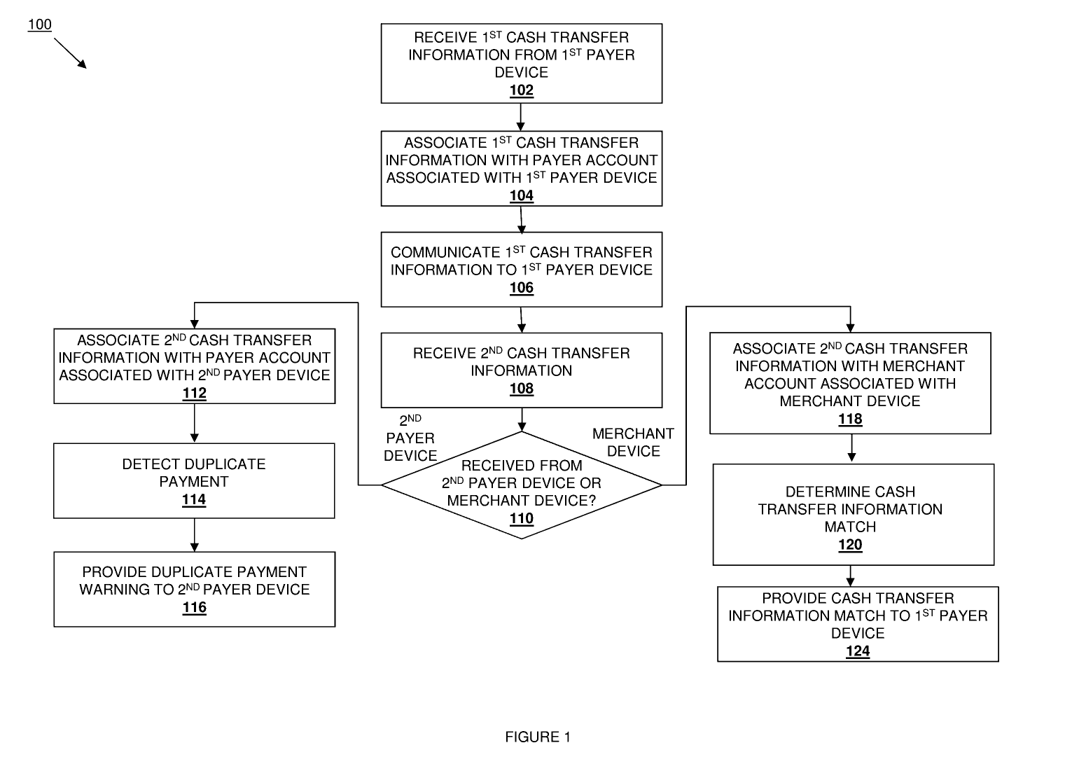

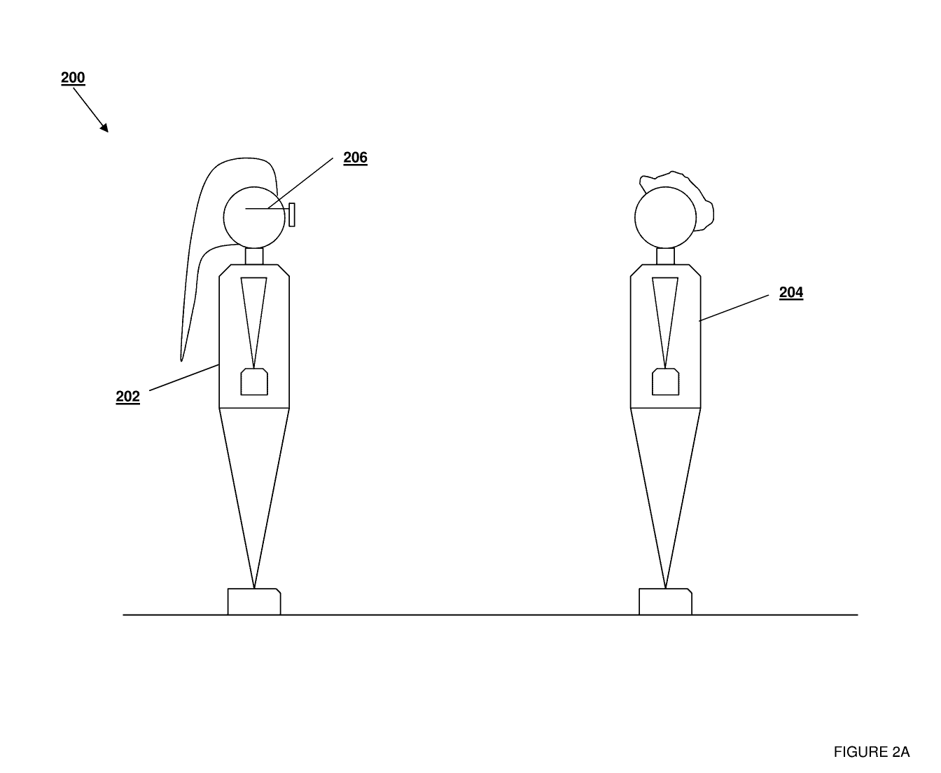

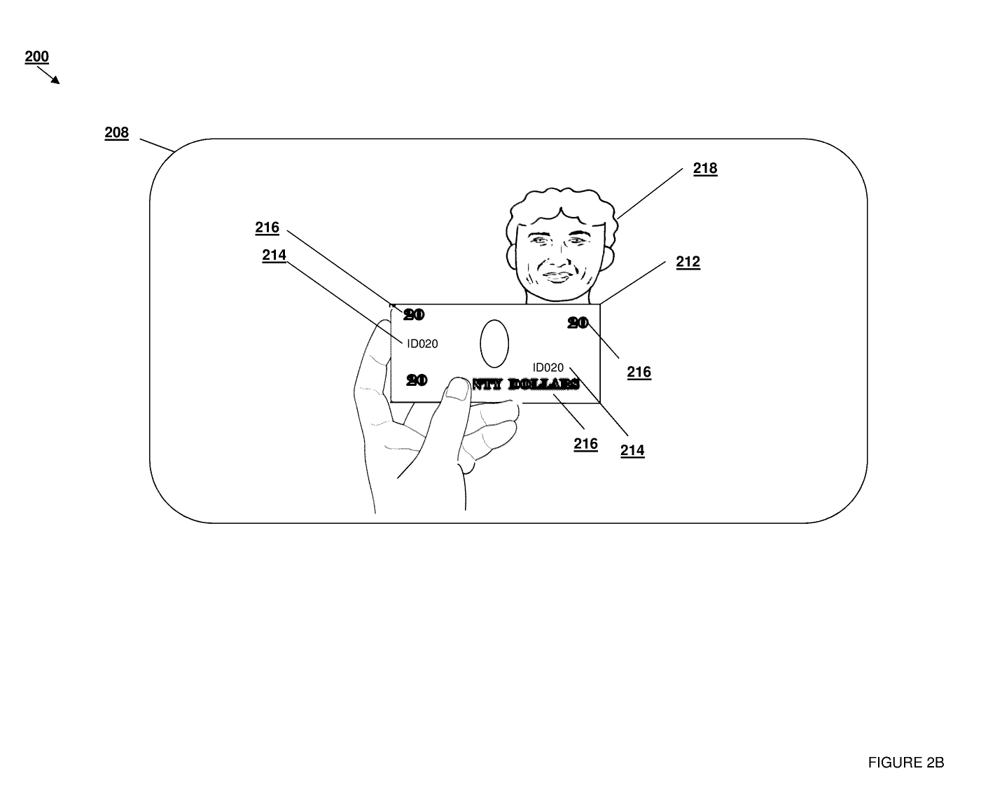

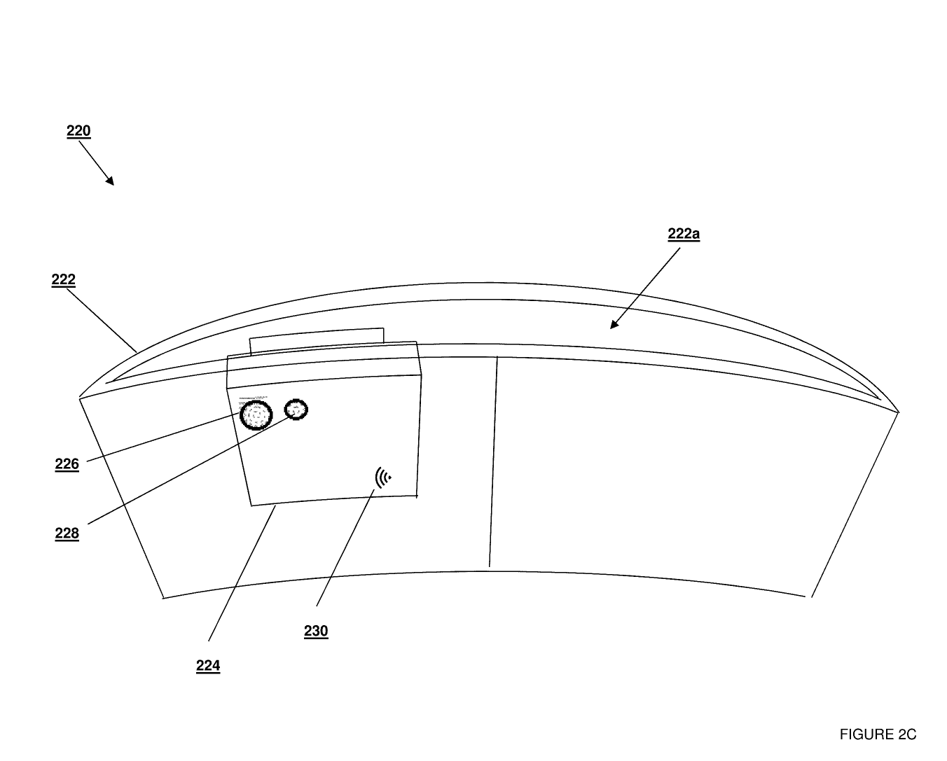

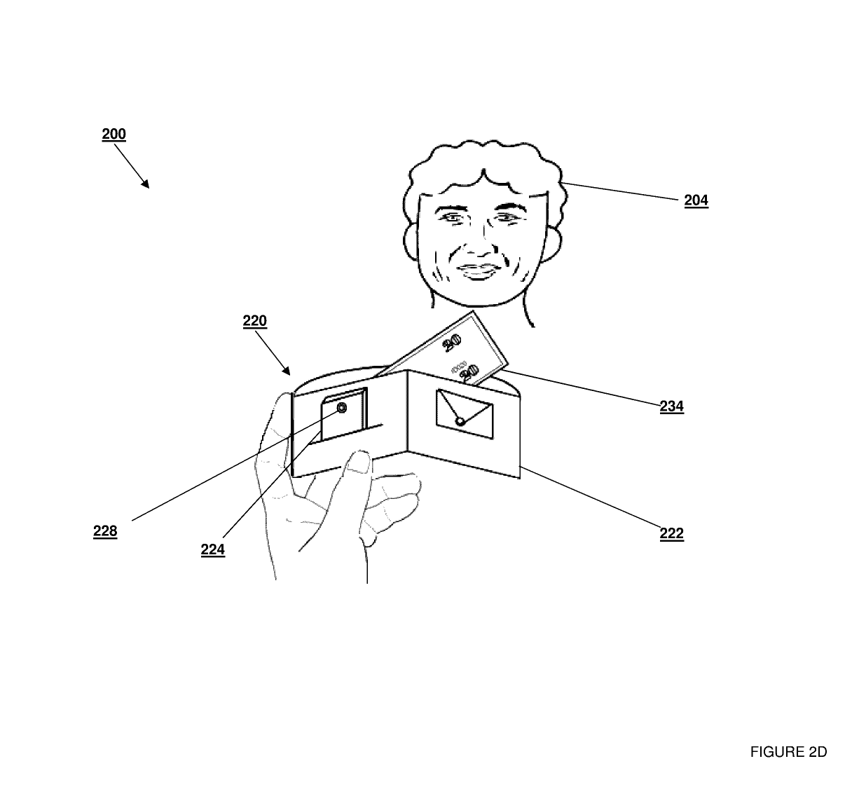

Referring now to FIG. 1, an embodiment of a method 100 for providing cash transaction tracking is provided. The method 100 begins at block 102 where first cash transfer information for a first cash transaction is received from a first payer device used in the first cash transaction by a first payer. As discussed in detail below with reference to FIGS. 2A-2D, various embodiments of one or more payer devices may be used during a cash transaction, and the payer device(s) may be configured to capture cash transfer information associated with the cash transaction. As discussed below, the payee in the cash transaction may be an individual providing products/services, or a merchant with a physical merchant location providing products/services, and/or other individuals, merchants, and/or other entities receiving cash from the payer. At block 102, a wide variety of cash transfer information regarding the cash transaction may be captured by the payer device. In some embodiments, cash transfer information may include physical bill information for the physical bill(s) used in the cash transaction, payee information for the payee in the cash transaction, product/service information for product/service purchased in the cash transaction, a time of the cash transaction, a location of the cash transaction, image captured during the cash transaction (e.g., a physical bill image, a payee image, a product/service image, etc.), a status of the cash transaction (e.g., completed, cancelled, pending, etc.), and/or a variety of other information known in the art that may be used to identify, categorize, and otherwise track the cash transaction. At block 102, in some embodiments, the payer device may save the cash transfer information and/or send cash transfer information over a network such as, for example, the Internet. For example, the payer device may send cash transfer information to a system provider device that operates to provide the cash transaction tracking system (e.g., a payment system provider device operated by a payment system provider, a merchant device operated by a merchant, a third-party system provider device operated by a third-party system provider, and/or any other provider of the cash transaction tracking system).

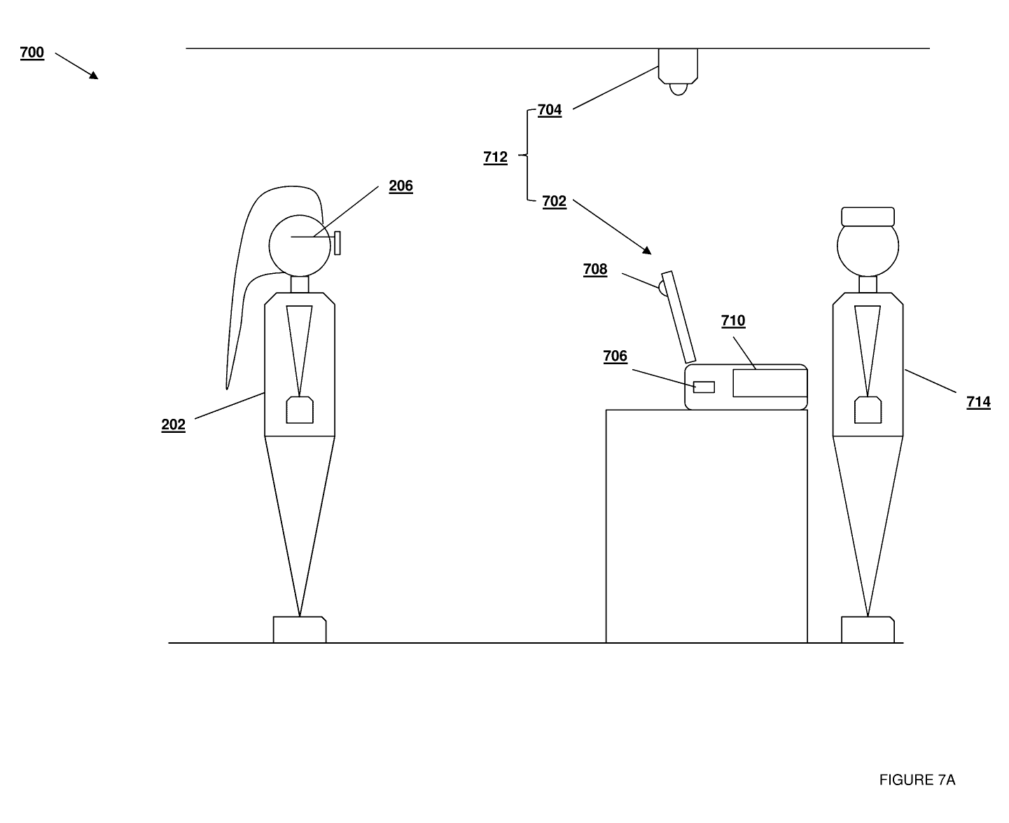

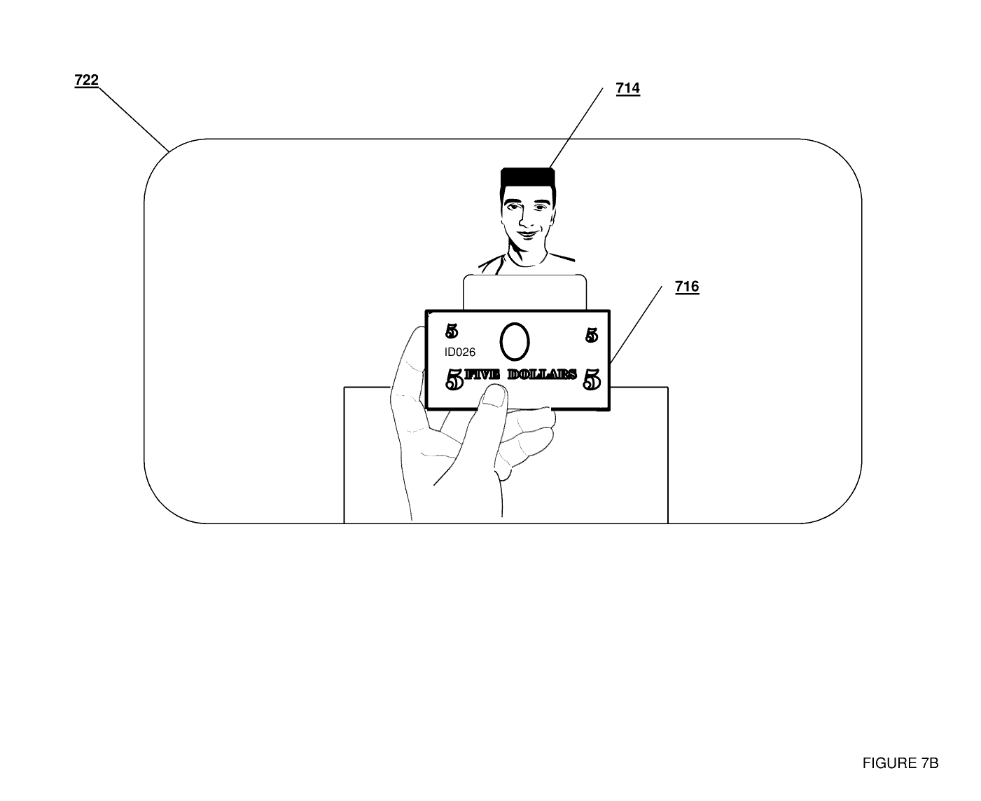

Referring now to FIGS. 2A-2D, various embodiments of a payer device being used in a cash transaction are illustrated. In the embodiments illustrated in FIGS. 2A-2D, the payee is illustrated as an individual. However, in some embodiments, the payee 204 may be a merchant at a merchant physical location, which will be discussed in detail below with reference to FIGS. 7A-7B.

FIGS. 2A-2B illustrates an embodiment of a payer device 206 being used in a cash transaction. As illustrated in the embodiment of FIG. 2A, a payer device 206 is being used by a payer 202 during the cash transaction 200 with the payee 204. In the illustrated embodiment of FIG. 2A, the payer device 206 is a wearable device (e.g. Google Glass® available from Google Inc. of Mountain View, Calif.), but as discussed below, the payer device 206 may be other types of devices (wearable or not) while remaining within the scope of the present disclosure. As is known in the art of cash transactions, the payer 202 may be in a position during the cash transaction (e.g., facing the payee 204) such that the payer device 206 may capture an image of the payee 204.

With reference to FIG. 2B, an embodiment of an image that may be captured by the payer device 206 used during cash transaction 200 is illustrated via a cash transfer information image 208 that also illustrated a first person view of the payer 202. As illustrated in FIG. 2B, cash transfer information detection image 208 may include a physical bill image 212 of the physical bill and a payee image 218 of the payee 204. In some embodiments, during cash transaction 200, the payer 202 may take out a physical bill, and prior to or during the handing of the physical bill to the payee 204, may hold the physical bill in a way that the payer device 206 may capture an image of the physical bill. For example, the physical bill may be held flat with a serial number side (e.g., front side of a US Dollar bill) facing the payer 202, and the payer device 206 may capture an image of the serial number side of the physical bill. For further example, the physical bill may be held flat with the other (non-serial number) side facing the payer 202, and the payer device may capture an image of the other side of the physical bill. In some embodiments, the payer 202 may instruct the payer device 206 when to capture the cash transfer information detection image (e.g., via a voice command, a selection of a physical or graphical input, etc.). In other embodiments, the payer device may continuously capture images during the cash transaction 200 that may be analyzed later in order to extract the cash transfer information discussed below. For example, the payer device 206 may be informed (e.g., by the payer 202) or may recognize the beginning of the cash transaction 200 and, in response, may begin capturing images/video until the payer device 206 determines that the cash transaction has ended.

As is known in the art, the physical bill image 212 includes various portions having a variety of information about the physical bill. For example, the physical bill image 212 includes serial number portions 214, which includes information about a serial number (e.g., “ID020”) of the physical bill. In another example, the physical bill image 212 includes amount portions 216 including information about the amount (e.g., twenty dollars) of the physical bill. In another example, the physical bill image 212 may include currency type portions including information about the currency type (e.g., US Dollar) of the physical bill. In some embodiments, the various portions (e.g., the amount portions 216 and the currency type portions) of the physical bill image 212 may overlap. In many embodiments, during the cash transaction 200, the payer 202 is in a position (e.g., facing the payee 204) such that the payer device 206 may also capture an image of the payee 202. In an example, the payee image 218 may include an image of the payee 204's face. In some embodiments, cash transfer information detection screen 208 may be an image captured by the payer device 206 (e.g., by a camera on the payer device 206), and provided on a display of the payer device 206.

In some embodiments, the payer device 206 may further analyze the cash transfer information detection image 208 to extract, determine, or otherwise provide cash transfer information (e.g., physical bill information, payee information, and/or other cash transfer information that may be included in the cash transfer information detection image 208). While the analysis of cash transfer information detection image 208 will be discussed below as being performed in the payer device 206, in some embodiments, cash transfer information detection image 208 may be sent to the system provider device and then analyzed by the system provider device to provide the cash transfer information while remaining within the scope of the present disclosure.

In an embodiment, the payer device 206 may analyze the cash transfer information detection image 208 to provide cash transfer information that includes physical bill information. The physical bill information may include a serial number of the physical bill, and that serial number of the physical bill may be unique to the physical bill and be used as a unique identifier for a physical bill of a particular currency type. In those and/or other embodiments, the physical bill information may include an amount of the physical bill, a currency type of the physical bill, and/or other information about the physical bill that may be extracted from the cash transfer information detection image 208. In some embodiments, the payer device 206 may analyze the physical bill image 212 in cash transfer information detection image 208 to determine the physical bill information of the physical bill used in cash transaction 200. In an example, the payer device 206 may include an image/pattern/text recognition engine (e.g., an optical character recognition (OCR) engine) that analyzes the physical bill image 212 to provide physical bill information. In the example illustrated in FIG. 2B, the payer device 206 may analyze the serial number portions 214 of the physical bill image 212 to recognize a serial number (e.g., “ID020”) of the physical bill information, may analyze the amount portions 216 to recognize an amount (e.g., twenty dollars) of the physical bill information, and may analyze the entire pattern of physical bill image 212 or currency portions of the physical bill image 212 to provide a currency type (e.g., US Dollar) of the physical bill information. While the analysis of the physical bill image 212 has been discussed as being performed in the payer device 206, in some embodiments, the physical bill image 212 may be sent to the system provider device and then analyzed by an image/pattern/text recognition engine in the system provider device to provide the physical bill information while remaining within the scope of the present disclosure. Furthermore, while FIG. 2B illustrated a single physical bill, one or more physical bills and/or coins may be captured and analyzed to provide the cash transfer information discussed above while remaining within the scope of the present disclosure.

In another embodiment, the payer device 206 may analyze the cash transfer information detection image 208 to provide cash transfer information that includes payee information. In an example, the payee 204 is an individual, and the payee information may include the name of the payee 204. In another example, the payee is a merchant, and the payee information may include the name of the merchant. To provide such payee information, the payer device 206 may analyze the payee image 218 of cash transfer information detection screen 208 and may utilize other databases or information storage systems in order to determine the payee information. For example, the payer device 206 may include an image/face recognition engine that analyzes the payee image 218 and compares the elements of the payee image to a database of payee faces stored in the payer device 206 or another database that is accessible over the network. While the analysis of the payee image 218 has been discussed as being performed in the payer device 206, in some embodiments, the payee image 218 may be sent to the system provider device and then analyzed by an image/face recognition engine in the system provider device to determine the payee information while remaining within the scope of the present disclosure. For example, the payer device 206 may send the payee image 218 over the network to an online social networking server (e.g., a Facebook server provided by Facebook, Inc. of Menlo Park, Calif.) and receive the payee information from the online social networking server (e.g., provided by an image/face recognition engine of the online social networking server).

In some embodiments, multiple physical bills may be used in cash transaction 200. Multiple physical bill images (e.g., front and/or back) may be captured and/or analyzed to provide the cash transfer information that includes physical bill information for the cash transaction 200. In one example, cash transfer information may include physical bill information for all of multiple physical bills used in cash transaction 200. In such embodiments, the payer 202 may be required to shuffle through, or otherwise separately provide the physical bills in front of the payer device 206 such that cash transfer information may be captured for each of those physical bills in order to perform the image analysis and cash transfer information retrieval for each of those physical bills as discussed above.

In some embodiments, the payer 202 may receive one or more physical bills (and/or coins) from the payee 204 (e.g., as change in the cash transaction). In one example, cash transfer information for the cash transaction 200 may include information regarding these physical bills and/or coins used in change. Similarly as discussed above, images of the physical bill(s) and/or coins received by the payer 202 from the payee 204 may be captured and analyzed to provide the cash transfer information discussed above. Thus, while the provisioning of cash transfer information for physical bills has been illustrated above in FIGS. 2A and 2B, one of skill in the art in possession of the present disclosure will recognize that at least some of the cash transfer information discussed above may be captured for coins as well. For example, while coins may not include serial numbers, currency type, denomination, and/or other coin-related cash transfer information may be captured and extracted from the cash tracking information detection images substantially as discussed above. Thus, the payer device 206 may be configured to recognize the direction of a cash transfer (e.g., by detecting to handing of bills and/or coins from a payer to a payee, or subsequently from a payee to a payer) in order to determine whether a payment is being made or change is being provided for a payment. Such functionality can be realized using the image recognition discussed above, audio recognition, explicit commands issued by the payer, and/or in any other manner that would indicate the direction of the cash transfer.

In some embodiments, the payer device 206 may capture, retrieve, or otherwise receive product/service information about the purchased product/service that is part of the cash transaction and associated the product/service information with the cash transfer information. For example, the payer device 206 may include a Near Field Communication (NFC) system or Radio Frequency Identification (RFID) system that can retrieve product identifiers from NFC or RFID devices on products and associate those product identifiers with the cash transfer information. In another example, the payer device 206 may scan a barcode that is located on the purchased product, and a scanning engine on the payer device 206 or the system provider device may analyze the scanned barcode and associate the scanned barcode information with the cash transfer information. In another example, the payer device 206 may capture a product/service image of the product/service, and an image recognition engine on the payer device 206 or the system provider device may analyze the product/service image to determine the product/service information that is then associated with the cash transfer information. While a few examples have been provided for capturing product/service information, any systems and methods for determining and providing product/service information are envisioned as falling within the scope of the present disclosure.

In some embodiments, the payer device 206 may provide cash transfer information that includes a location. In some embodiments, the payer device 206 provides the location based on the location of the payer 202 and/or the payer device 206. For example, the payer device 206 may include a location determination device (e.g., a Global Positioning System (GPS) device, a cell tower triangulation device, a WiFi location determination device, and/or a variety of other location determination devices known in the art) to determine location data related to a current location of the payer device 206. For example, the payer device 206 may be a mobile phone or wearable device that changes locations as the payer 202 moves, and may provide the payer 202's current location using the location determination device discussed above. In some embodiments, the payer 202 may be prompted by the payer device 206 to provide the payer's current location to the payer device 206. In some embodiments, the payer device 206 may look up the location of the payer device 206 in a database. For example, the payer device 206 may be a home surveillance system that is typically located in one particular location, and the payer 202 may have provided location data associated with that particular location (e.g., the payer 202's home) in that database.

In some embodiments, the system provider device may provide the cash transfer information that includes the location. For example, the system provider device may retrieve location data determined by the mobile payer device 206 over the network. In another example, the system provider device may retrieve the location data retrieved by a home surveillance system as discussed above over the network. In an embodiment, the system provider device may look up the location of the payer device 206 in a database. For example, the payer 202 may provide or have provided location data associated with the payer device 206's location (e.g., the payer's home) to the system provider device.

In some embodiments, the payer device 206 may provide cash transfer information that includes a time of cash transaction 200. For example, the payer device 206 may provide the time of cash transaction 200 based on a clock of the payer device 206. In some embodiments, the system provider device may provide a time of the cash transaction (e.g., using a clock of the system provider device) in response to receiving the cash transfer information for cash transaction 200 from the payer device 206.

In some embodiments, the payer device 206 may be configured to receive cash transfer information though audio provided by the payer 202. For example, the payer 202 may provide descriptions of the details of cash transaction 200 by speaking into the payer device 206, and a microphone or other audio capturing system in the payer device 206 may be configured to capture the spoken description, convert it to cash transfer information, and store the cash transfer information. In another example, the spoken description may include any of the cash transfer information discussed above including physical bill information (e.g., serial number, amount, currency type), payee information, the product/service information, location, time, status of the cash transaction (e.g., completed, cancelled, or pending), and/or other cash transaction details. In another example, a speech recognition engine in the payer device 206 may be configured to analyze the audio of the spoken description of the details of cash transaction 200 to provide the cash transfer information. While the analysis of the audio of the spoken description has been discussed as being performed in the payer device 206, in some embodiments, the audio of the spoken description may be sent to the system provider device and then analyzed by a speech recognition engine in the system provider device to determine cash transfer information, while remaining within the scope of the present disclosure.

A variety of devices may be suitable to for implementing the payer device 206. In the illustrated example, the payer device 206 is a wearable device (e.g. Google Glass® available from Google Inc. of Mountain View, Calif.). However, in another example, the payer device 206 may be a mobile phone or other mobile computing device known in the art. One of skill in the art will recognize a variety of other portable/mobile payer devices and/or wearable payer devices may be utilized, in at least some embodiments, without departing from the scope of the present disclosure.

Referring now to FIGS. 2C-2D, another embodiment of a payer device 220 is illustrated. While the majority of the discussion below refers to the payer device 206 illustrated in FIG. 2A, it should be understood that the payer device 220 may be used in place of, or in combination with, the payer device 206. As illustrated in the embodiment of FIG. 2C, the payer device 220 includes a wallet 222 having a frame supporting a cash transfer information capturing device 224. The cash transfer information capturing device 224 may include a camera 228, a microphone 226, a speaker 230, a scanner device (not illustrated), a wireless communications device (not illustrated), and/or other subsystems that may be utilized to capture the cash transfer information described herein. For example, the cash transfer information capturing device 224 may include a portable Wi-Fi camera that may provide a payer 202 with the functionality with reference to the methods discussed herein. However, a variety of other cash transfer information capturing devices may be provided with the wallet 222 in the methods discussed herein without departing from the scope of the present disclosure.

As illustrated in FIG. 2C, the cash transfer information capturing device may 224 be positioned on the wallet 222 such that a portion of the cash transfer information capturing device 224 is located adjacent a cash channel/housing 206a defined by the wallet 206, and a portion of the cash transfer information capturing device 224 may be located opposite the wallet 222 from the cash channel/housing 222a (e.g., such that the camera 228, microphone 226, and speaker 230 are exposed when the wallet 222 is opened as illustrated in FIG. 2C). As discussed above, the cash transfer information capturing device 224 may include a scanning device, and that scanning device may be located in the cash channel/housing 206a in the embodiment illustrated in FIG. 2C. While not illustrated, the cash transfer information capturing device 224 may include cameras, microphones, speakers, and/or other subsystems that are exposed when the wallet 222 is closed (e.g., on an opposite side of the wallet 222 than illustrated in FIG. 2C). As such, subsystems to capture the cash transfer information may be positioned in multiple locations on the wallet 222 to capture cash transfer information while remaining within the scope of the present disclosure.

Referring now to FIG. 2D, a first person view of an embodiment of the payer device 220 of FIG. 2C being used in cash transaction 200 is illustrated. As illustrated in FIG. 2D, a payer may take out the payer device 220 and hold the wallet 222 of the payer device 220 in the payer's hand(s) in manners known in the art. The payer may take out a physical bill 234 from the payer device 220 to make a cash payment to a payee 204. In an embodiment, the payer device 222 may be held in a way that allows the cash transfer information capturing device 224 to capture information about the physical bill 234, the payee 204, and/or other cash transfer information described herein. In an example, the cash transfer information capturing device 224 in the payer device 220 may capture a physical bill image of the physical bill 234 using the camera 228 or the scanning device. In another example, the cash transfer information capturing device 224 in the payer device 220 may capture the serial number and/or amount of the physical bill 234 using the camera 228 or the scanning device. In another example, the cash transfer information capturing device 224 in the payer device 220 may capture a payee image of the payee 204 using the camera 228. In one example, similar to the payer device 206 discussed above with reference to FIGS. 2A-2B, the payer device 220 may analyze the physical bill image, the payee image, the physical bill scanning data, and/or other information captured by the cash transfer information capturing device 224 to determine the physical bill information and payee information. In another example, the payer device 206 may send the physical bill image, physical bill scan data, the payee image, and/or other captured information to the system provider device, and the system provider device determines the physical bill information, payee information, and/or other cash transfer information.

In some embodiments, the payer device 220 may include other environment sensors such as accelerometers, network communication devices, and/or a variety of other sensors known in the art for determining and transmitting cash transfer information, and as such may provide other functions related to cash transaction 200. In an example, an infrared sensor on the cash transfer information capturing device 224 in the payer device 220 may be used to detect counterfeit physical bills (e.g., by capturing an image or scan data of a physical bill and comparing that data to counterfeit detection data stored in a database). A determination of a possible counterfeit bill transaction may also be based on detecting a physical bill with the same serial number or unique identifier at two different locations within a certain time period, where the time period may be selected based on distance that a bill may practically be able to travel during that time. Thus, when a second bill having the same unique identifier is detected as one used in a previous location (within the distance and time parameters), an alert may be provided to both payees (or payers) at those locations that one or both bills may be counterfeit. In another example, a wireless communication device in the payer device 206 may be used to transmit and receive information, e.g., cash transfer information over the network.

As discussed below, the payer 202 may utilize the microphone 226 and/or speaker 230 on the cash transfer information capturing device 224 in order to provide cash transfer information in combination with the cash transfer information captured as discussed above. For example, when the cash transfer information capturing device 224 captures images and/or scan data of the physical bills 234, the payer 202 may speak in a manner that is captured by the microphone to provide cash transfer information such as a product being purchased, a budget to apply the purchase to, a reason for the purchase, and/or any other purchasing information that may be relevant to the cash transaction 200.

In some embodiments, the payer 202 may use the payer device 220 to provide the system provider device with payer information of payer 202 over the network. For example, payer information of payer 202 may include a user name, a user identification number, a user account number, a user password, and/or a variety of other information known in the art for associating the payer 202 with a payer account. In some embodiments, the payer 202 may sign into an account with the system provider device before or during cash transaction 200. Thus, the system provider device may receive information associated with a cash transaction involving an individual/merchant from a payer device, and the information may include cash transfer information describing the cash transaction, and payer information that is associated with a payer account.

While a few example of the provision of receiving cash transfer information from the payer device 220 have been provided, one of skill in the art in possession of the present disclosure will recognize that a wide variety of systems and methods for providing, receiving, storing, and/or otherwise communicating cash transfer information at block 102 will fall within the scope of the present disclosure.

Referring now to FIGS. 1, 3, and 4, the method 100 then proceeds to block 104, where the first cash transfer information is associated with a first payer account associated with the first payer device. In some embodiments, various associations may be used to associate a payer account with a payer device, including associating the payer device with the payer account during payer account setup (e.g., providing a phone number, a device ID, an Internet Protocol (IP) address, and/or other payer device identifier for association with the payer account). At block 104, that association may be used to determine the payer account associated with the payer device that provided the cash transfer information at block 102. In an example, multiple payer accounts may be associated with the payer device 206, each using a particular association to link the payer device 206 with that payer account. As such, in some embodiments, the payer device 206 and/or payer 202 may identify which of multiple accounts the cash transfer information should be associated with. In another example, an owner/primary user association may be used to associate a payer that is the owner/primary user of the payer device 206 with the payer device 206 and a payer account, while a secondary association may be used to associate another payer (e.g., that belongs to the same household as the owner/primary user) with a secondary payer device and the payer account. In an example, at block 104, the payer device 206 may determine the payer account associated with the cash transfer information captured at block 102. In another example, at block 104, the system provider device may determine the payer account associated with the payer device 206 and the cash transfer information captured at block 102.

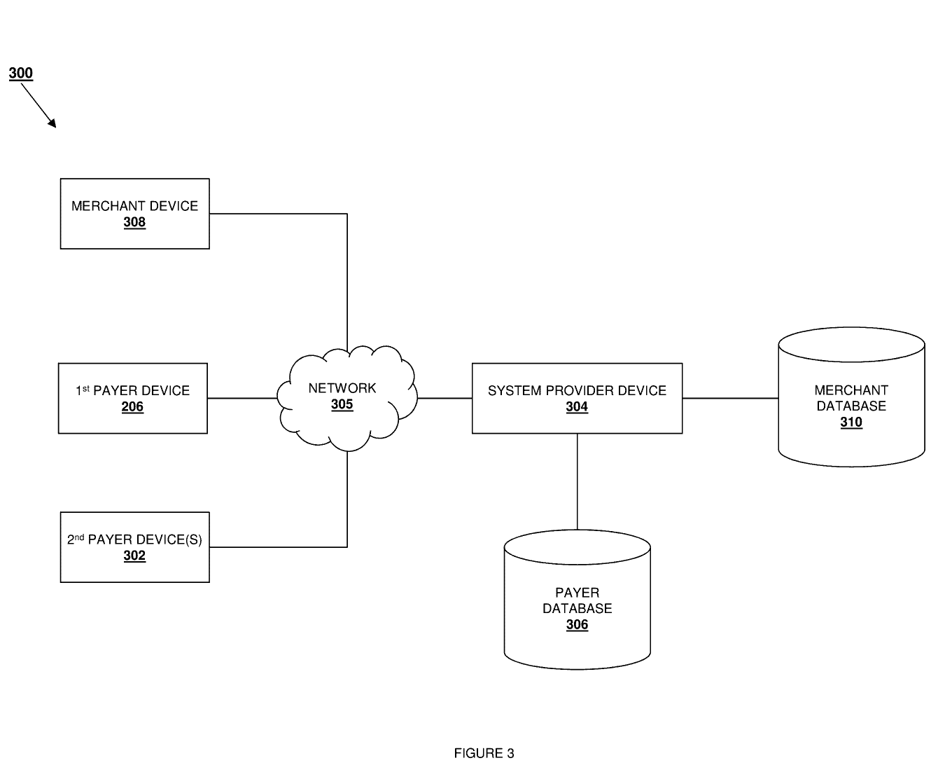

Referring now to FIG. 3, an embodiment of a cash transaction tracking system 300 is illustrated. The cash transaction tracking system 300 includes a system provider device 304 communicatively coupled through a network 305 to a first payer device 206, at least one second payer device 302, and a merchant device 308. The system provider device 304 is further communicatively coupled to a payer database 306 and a merchant database 310, which will be discussed in detail below with reference to FIGS. 7A-7B. While illustrated as multiple databases that are directly connected to the system provider device 304, the payer database 306 and the merchant database 310 may be provided in a single database, and/or may be coupled to the system provider device 304 by the network 305.

In some embodiments, as discussed above with reference to FIGS. 2A-2D, the system provider device 304 may receive cash transfer information from the payer device 206. In some embodiments, the system provider device 304 may further analyze cash transfer information received from the payer device 206 (e.g., the physical bill image 212, the payee image 218, audio of the spoken description, scan data, etc.). In some embodiments, at block 104, the system provider device 304 may associate cash transfer information with a payer account, where the payer account is associated with the first payer device 206 and/or the second payer device(s) 302 (as discussed below). Similarly, the system provider device 304 may associate cash transfer information received from the merchant device 308 with a merchant account as well.

In some embodiments, the system provider device 304 may determine the payer account for associating cash transfer information using the payer device identifier discussed above. In another example, the system provider device 304 may determine the payer account for associating cash transfer information by using the payer information of the payer 202 received from the cash transfer information capturing device 224 in the payer device 206 as discussed above with reference to FIGS. 2A-2D. In another example, the system provider device 304 may look up the payer account associated with the payer device 206 with a particular association (e.g., an owner/primary user association, a secondary user association, etc.) using identifiers received from the payer device, payer information received from the cash transfer information capturing device 224, and a database stored in the system provider device 304 or accessible over the network.

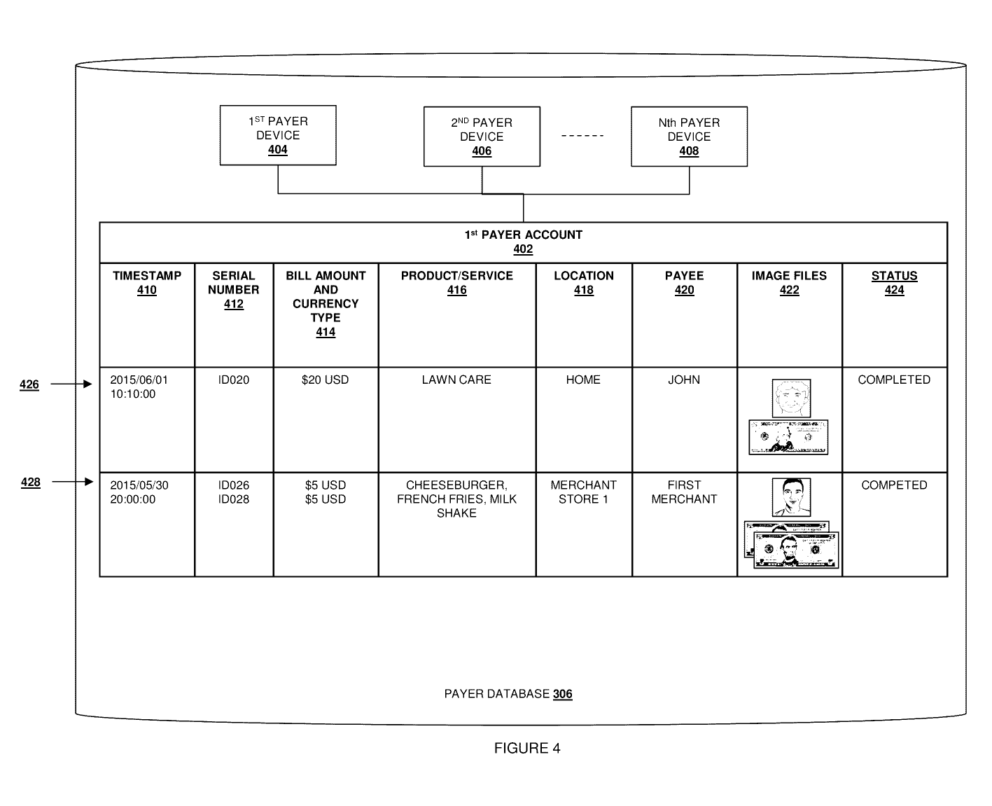

Referring now to FIG. 4, an embodiment of a payer database 306 is illustrated in which cash transfer information 426 for the cash transaction 200 has been associated with a first payer account 402, where the first payer account 402 is associated with the payer device 206 used in cash transaction 200. As illustrated in the embodiment of FIG. 4, a first payer device 404 (e.g., the first payer device 206 discussed above), as well as a second payer device 406, and up to an Nth payer device 408 may be associated with the payer account 402. One of skill in the art in possession of the present disclosure will recognize that the payer database 306 may include any number of payer accounts associated with payers and/or payer devices in a similar manner. In some embodiments, each payer account includes a table with various columns. In the illustrated example, the first payer account 402 may include columns that provide a time field 410, a serial number field 412, a cash amount and currency type column 414, a product/service field, a location field 418, a payee field 420, an image files field 422, and a status field 424 for any of a plurality of rows in the first payer account 402 that identify a cash transfer or transaction.

It is noted that payer database 306 illustrated in FIG. 4 is provided as just some examples of cash transactions that may be tracked by the cash transaction tracking system. The cash transaction tracking system of the present disclosure will be beneficial for a wide variety of other types of cash transactions, and thus the tracking of those cash transaction is envisioned as falling within the scope of the present disclosure. As such, the payer accounts of the payer database 306 may include other columns corresponding to a variety of other information known in the art for identifying cash transactions.

In some embodiments, the payer accounts may be associated with personal finance systems (e.g. Quicken® available from Intuit, Inc. of Mountain View, Calif.). For example, the first payer account 402 may be associated with a personal finance system for the first payer, and in some embodiments, the first payer account 402 may be associated with a personal finance system for a household including multiple individuals. In some embodiments, the personal finance system may compile cash transfer information of the first payer account 402 and/or other payer accounts associated with the personal finance system, and may use that cash transfer information to generate various personal finance reports (e.g., expense report, cash flow report).

In the embodiment illustrated in FIG. 4, the system provider device 304 has stored first cash transfer information 426 for a first cash transaction (e.g., the cash transaction 200 discussed above) in the first payer account 402 of the payer database 306. The first cash transfer information 426 may be stored in the different fields of a particular row of the first payer account 402. For example, the time field 410 for the particular row may include the time (e.g., “2015/06/01 10:10:00”) the cash transfer information 426 was generated and/or received. The serial number filed 412 and the amount and currency type field 414 for the particular row may store the serial number (e.g., “ID020”) and the amount and currency type (e.g., “$20 USD”) of the physical bill information captured in cash transfer information by the payer device 206 (e.g., using images, scan data, etc.). The product/service field 416 for the particular row may include the product/service information (e.g., “LAWN CARE”) captured in the cash transfer information by the payer device 206 (e.g., using images, audio data, etc.). The location field 418 for the particular row may include the location (e.g., “HOME”) captured in the cash transfer information by the payer device 206 (e.g., using location determination data, audio data, images, etc.). The payee field 420 for the particular row may include the payee information (e.g. “JOHN”) captured in the cash transfer information by the payer device 206 (e.g., using images, audio data, etc.). The image files field 422 for the particular row may include the image files (e.g. physical bill image 212 and payee image 218) provided by the payer device 206. The status field 343 for the particular row may include the status (e.g., “COMPLETED”) captured in the cash transfer information by the payer device 206 (e.g., audio data, images, etc.).

In the embodiment illustrated in FIG. 4, the system provider device 304 has also received and stored second cash transfer information 428 of a second cash transaction from the payer device 206. The second cash transaction is different from the first cash transaction discussed above. The system provider device 304 associates the second cash transfer information 428 with the first payer account 402 that is associated with the payer device 206, and stores the second cash transfer information 428 in a particular row of the first payer account 402 similarly as discussed above for the first cash transfer information 426. In the embodiments discussed below, the second cash transfer information 428 is associated with a second cash transaction 700 in which the payee is a merchant, as detailed below with reference to FIGS. 7A-B.

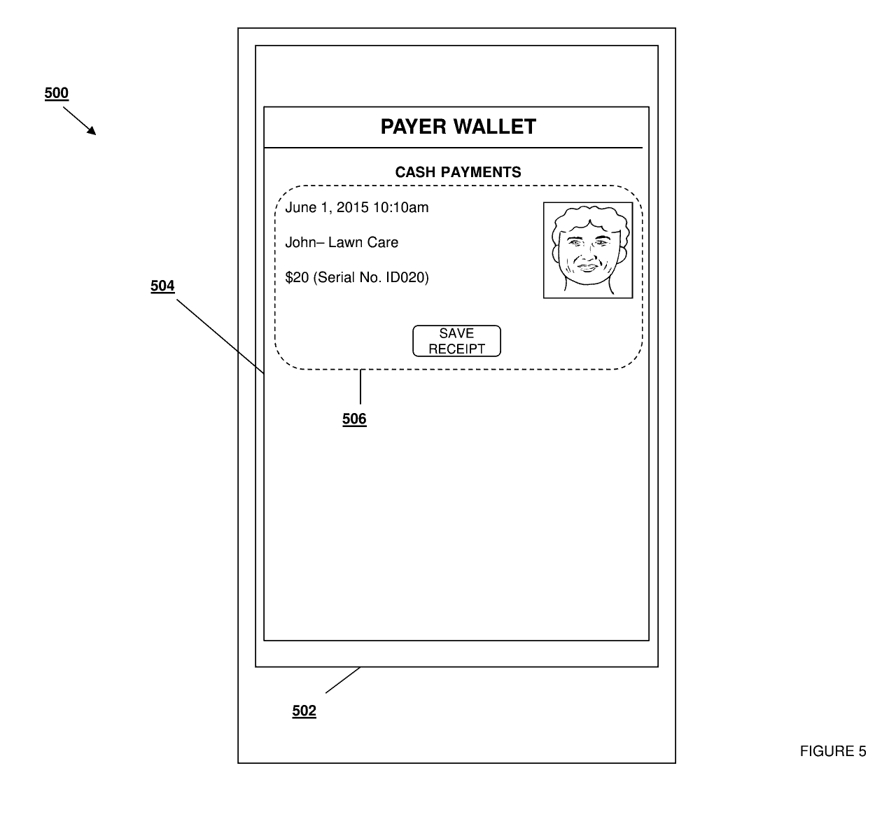

Referring to FIGS. 1 and 5, the method 100 proceeds to block 106, where the first cash transfer information is communicated to the first payer device. Referring now to FIG. 5, an embodiment of a payer device 500 is illustrated to provide examples of cash transfer information that may be communicated to a payer device. As illustrated in FIG. 5, the payer device 500 includes a display 502 displaying a cash transaction confirmation screen 504 that includes a receipt section 506 providing a receipt for the cash transaction 200. The cash transaction confirmation screen 504 includes a variety of cash transfer information that was captured for the cash transaction 200, including a time of the cash transaction (e.g. “Jun. 1, 2015 10:10 am”), payee information describing a payee in the cash transaction (e.g., “John”), product/service information describing a product or service involved in the cash transaction (“Lawn Care”), an amount and currency type used in the cash transaction (e.g., “$20”), a serial number (“ID020”) of the physical bill captured in the cash transaction, and an image files (e.g., the payee image 218) captured during the cash transaction. Using the specific example of the cash transaction confirmation screen 504 illustrated in FIG. 5, if the payer 202 would like to save the receipt (e.g., on the payer device 500, on the system provider device, or using any other suitable devices), the payer 202 may select the “SAVE RECEIPT” choice in the receipt section 506.

In a specific example of the systems and methods of the present disclosure, the cash transfer information communicated to the payer device as illustrated in FIG. 5 may have been captured and associated with the payer account of the payer 202 as follows. The payer device 206 may determine that a cash transaction is occurring by analyzing audio and/or images that indicate as such (e.g., detecting cash in an image, detecting audio data that indicates a cash transaction, etc.) The payer device 206 may then begin capturing images, audio, and/or other cash transfer information as discussed above. For example, the payer device 206 may capture images of the physical bill(s) being used in the cash transaction, the payee, etc. Furthermore, the payer device 206 may capture images and/or audio data that indicate that the cash transaction is associated with lawn care. Further still, the payer device may capture a current time and a location of the payer device 206. The payer device 206 (or a system provider device) may then analyze that cash transfer information to determine the current time, the payee name, the product/service, the physical bill information, and/or other cash transfer information, and associate it with a payer account that is linked to the payer device 206. Following that association, the receipt 506 may be created and displayed as illustrated on the payer device 500.

In some embodiments, the payer device 500 may be a variety of devices that the payer 202 uses. For example, the payer device 500 may be the payer device 206 used by the payer 202 during cash transaction 200 (e.g., the wearable payer device 206). However, in the illustrated example, the payer device 500 us a device used by the payer 202 (e.g., a mobile phone) that is different from the payer device 206 that captured the cash transfer information in the cash transaction 200. In other, non-illustrated embodiments, the payer device 500 may be a desktop computer and/or other computing devices known in the art.

The example illustrated and described above with reference to FIG. 5 is not intended to be limiting, and the information provided with the payer device 500 may be provided in a variety of manners (through an application, as a message (e.g., an email, a text message, a picture message, a “pop-up”), etc.) on a variety of different types of devices (e.g., mobile payer devices, relatively non-mobile computing device, etc.) without departing from the scope of the present disclosure.

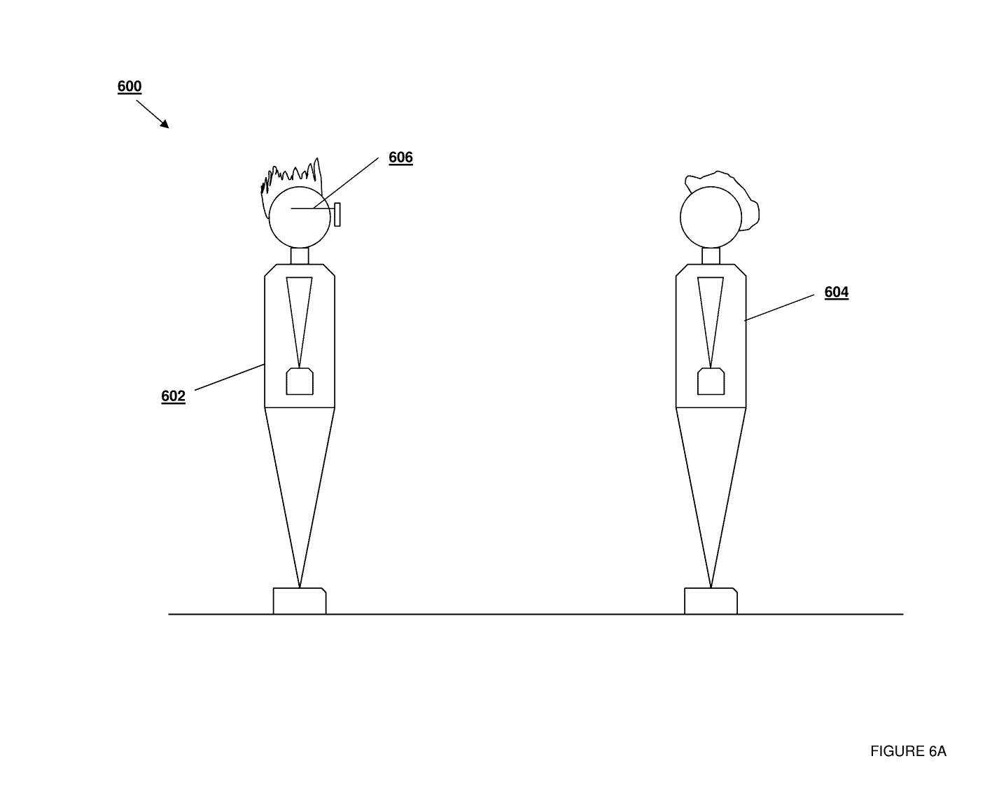

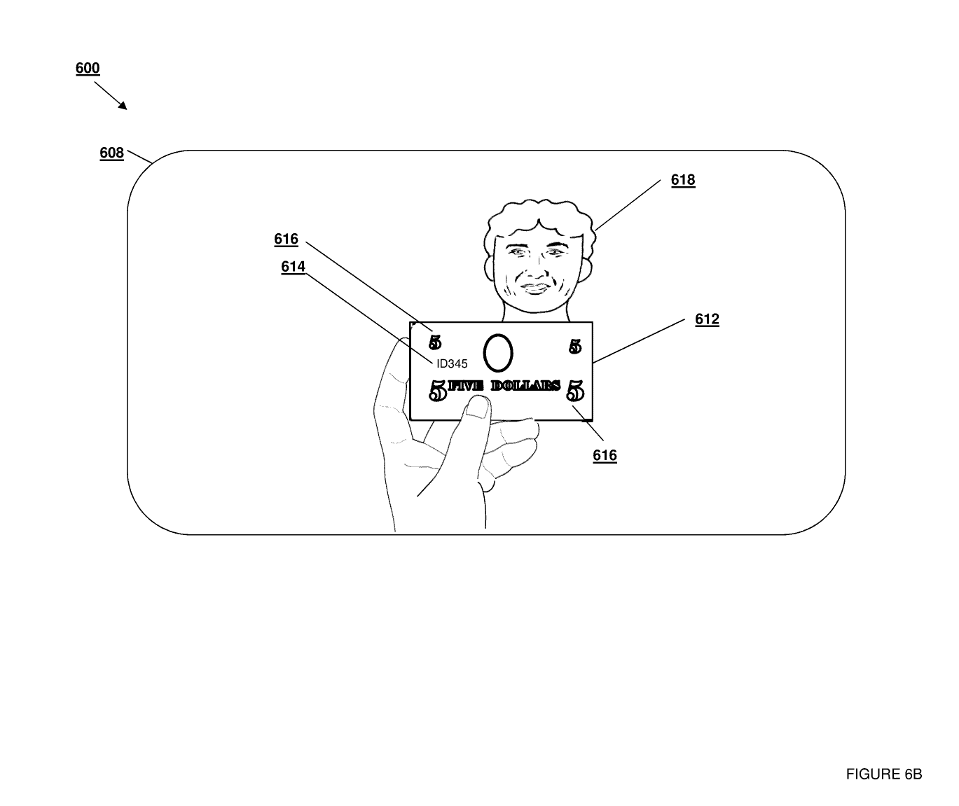

Referring to back to FIG. 1, the method 100 proceeds to block 108, where second cash transfer information is received. In some embodiments, second cash transfer information may be provided by a payer device, which is discussed in detail below with reference to FIGS. 6A-6B, or by a merchant device, which is discussed in detail below with reference to FIGS. 7A-7B.

Referring now to FIGS. 6A-6B, an embodiment of receiving second cash transfer information from a second payer device during a second cash transaction is illustrated. FIG. 6A illustrates an embodiment of a payer device 606 being used by a payer 602 during a second cash transaction 600, where the payer 602 pays a payee 604 with one or more physical bills. In some embodiments, the second cash transaction 600 may be a second cash transaction that happens after the first cash transaction 200. In the examples discussed below, the payer 602 is a different payer from the payer 202 of the cash transaction 200 and is associated with one or more payer accounts along with the payer 202. However, in another example, the payer 602 may be the same payer as the payer 202 of the first cash transaction 200. In the examples discussed below, the payee 604 is the same payee as the payee 204 of first cash transaction 200. However, in another example, the payee 604 may be a different payee from the payee 204 of the first cash transaction 200. In the embodiment illustrated in FIG. 6A, the payee 606 is an individual. However, in some embodiments, the payee 606 may be a merchant, as discussed in detail below with reference to FIGS. 7A-7B.

With reference to FIGS. 6A and 6B, an embodiment of a cash transfer information detection image 608 illustrated that provides a first person view of the payer 602 when the payer 602 takes out a physical bill and holds the physical bill during the second cash transaction 600. Substantially similar to cash transfer information detection image 208 described above with reference to FIG. 2B, the cash transfer information detection image 608 may include a physical bill image 612 of the physical bill and a payee image 618 of the payee 604. In some embodiments, as illustrated in FIG. 6B, the payee image 618 may include an image of the payee 604's face. In some embodiments, the physical bill image 612 may include various portions which include information about the physical bill. For example, the physical bill image 612 includes serial number portions 614 and amount portions 616. The serial number portions 614 include information about a serial number (e.g., “ID345”) of the physical bill. The amount portions 616 include information about the amount (e.g., five dollars) of the physical bill. For further example, the physical bill image 612 may include currency type portions including information about the currency type (e.g., US Dollar) of the physical bill.

Similar to cash transfer information for cash transaction 200 described above with reference to FIGS. 2A-2B, in some embodiments, the payer device 606 may analyze cash transfer information detection image 608, audio from the payer 602 that includes the details of second cash transaction 600, and other information related to second cash transaction 600, and provide cash transfer information to the system provider device 304. In some embodiments, the system provider device 304 may receive cash transfer information for second cash transaction 600 from the payer device 606 and may analyze cash transfer information for cash transaction 600 received from the second payer device 606.

Referring now to FIGS. 1 and 7A-B, at block 108, in some embodiments, the second cash transfer information may be received from a merchant device. Illustrated in FIGS. 7A-7B is an embodiment of receiving cash transfer information for a second cash transaction 700 from a merchant device 712. Referring to the embodiment of FIG. 7A, the payer 202 is making a cash payment at a merchant physical location during the second cash transaction 700. The merchant physical location may include the merchant device 712, which in the illustrated embodiment includes a cash register 702 and a camera 704 mounted over the cash register 702. In some embodiments, the cash register 702 may be operated by a cashier/merchant 714. In some embodiments, the payer 202 may use the payer device 206 during the second cash transaction 700. In some embodiments, the cash register 702 may include a bill scanner 706, a cash register camera 708, and/or a cash drawer 710. In one example, the cash drawer 710 may include a plurality of compartments that each accommodates physical bills of a common denomination.

In some embodiments, the merchant device 712 may receive cash transfer information from the cash register 702, and may further analyze the received cash transfer information. In one example, one or more physical bills used in the second cash transaction 700 (e.g., physical bills provided by the payer 202 to the cashier 714, and/or physical bills received by the payer 202 from the cashier 714 in change) may be detected by the bill scanner 706 prior to the physical bills being placed in or removed from the cash drawer 710, or during that process. In one example, the bill scanner 706 may capture a physical bill image of the physical bill(s). In another example, the bill scanner 706 may capture a serial number, an amount, a currency type, and/or other types of information about the physical bill discussed above. In some embodiments, the merchant device 712 may receive cash transfer information from the camera 704 mounted over the cash register 702 in substantially the same manner as discussed above for the payer device 206, and further analyze the received cash transfer information.

Referring to FIG. 7B, an embodiment of a cash transfer image 722 that may be captured by the payer device 206 during the second cash transaction 700 is illustrated. The cash transfer image 722 may include a physical bill image 716 of a physical bill being paid by the payer 202 to the cashier 714. The image 722 may also include a cashier image of the cashier 714 receiving the physical bill. In some embodiments, the payer device 206 may include an image/pattern/text recognition engine (e.g., an optical character recognition (OCR) engine) that further analyzes cash transfer information (e.g., the captured images including the physical bill image). The image/pattern/text recognition engine may be similar to the image/pattern/text recognition engine discussed above with reference to FIG. 2B. While the analysis of captured images has been discussed as being performed in the payer device 206, in some embodiments, the captured images may be sent to the system provider device 304 and then analyzed by an image/pattern/text recognition engine in the system provider device 304 to provide cash transfer information while remaining within the scope of the present disclosure.

In some embodiments, the merchant device 712 may include other environment sensors such as microphones, speakers, accelerometers, network communication devices, and/or a variety of other environment sensors known in the art for capturing and/or transmitting cash transfer information, and provide other functions related to the cash transaction.

In some embodiments, the system provider device 304 may receive cash transfer information for the second cash transaction 700 from the merchant device 712 at block 108. In some embodiments, the system provider device 304 may further analyze the cash transfer information for the second cash transaction 700 received from the merchant device 712 (e.g., the physical bill image 716, the cashier image 720, audio of the spoken description provided by the cashier 714) to determine cash transfer image specific to the second cash transaction 700.

Referring back to FIGS. 4 and 7A, the system provider device 204 may also receive cash transfer information for the second cash transaction 700 from the payer device 206. In the embodiment of FIG. 7A, the payer 202 may use a payer device 206 during the second cash transaction 700. Similar to the discussion above with reference to FIGS. 2A-2B, the payer device 206 may send cash transfer information to the system provider device 304, which may further associate cash transfer information with a payer account associated with the payer device 206. Referring back to FIG. 4, substantially similar to the cash transfer information 426 discussed above with reference to FIG. 4, cash transfer information 428 for the second cash transaction 700 that is received from the payer device 206 may be associated with the first payer account 402 in the payer database 306. For example, cash transfer information 428 may be populated in a particular row of the first payer account 402. The particular row includes a time field 410 for the time of the second cash transaction 700 (e.g., “2015/05/30 20:00:00”), a serial number field 412 for the serial number of the physical bill(s) used in the second cash transaction 700 (e.g., “ID026 ID028”), the bill amount and currency type field 414 for the amount and currency type of the physical bill(s) used in the second cash transaction 700 (e.g., “$5; $5”), a product/service field 416 for product/service information of the second cash transaction 700 (e.g., “CHEESEBURGER, FRENCH FRIES, MILK SHAKE”), a location field 418 for the location of the second cash transaction 700 (e.g., “MERCHANT STORE 1”), a payee field 420 for the payee information of the second cash transaction 700 (e.g., “FIRST MERCHANT”), an image files field 422 for the images captured during the second cash transaction 700 (e.g., the cashier image and/or the physical bill images), and a status field 424 for the second cash transaction 700 (e.g., “COMPELTED”).

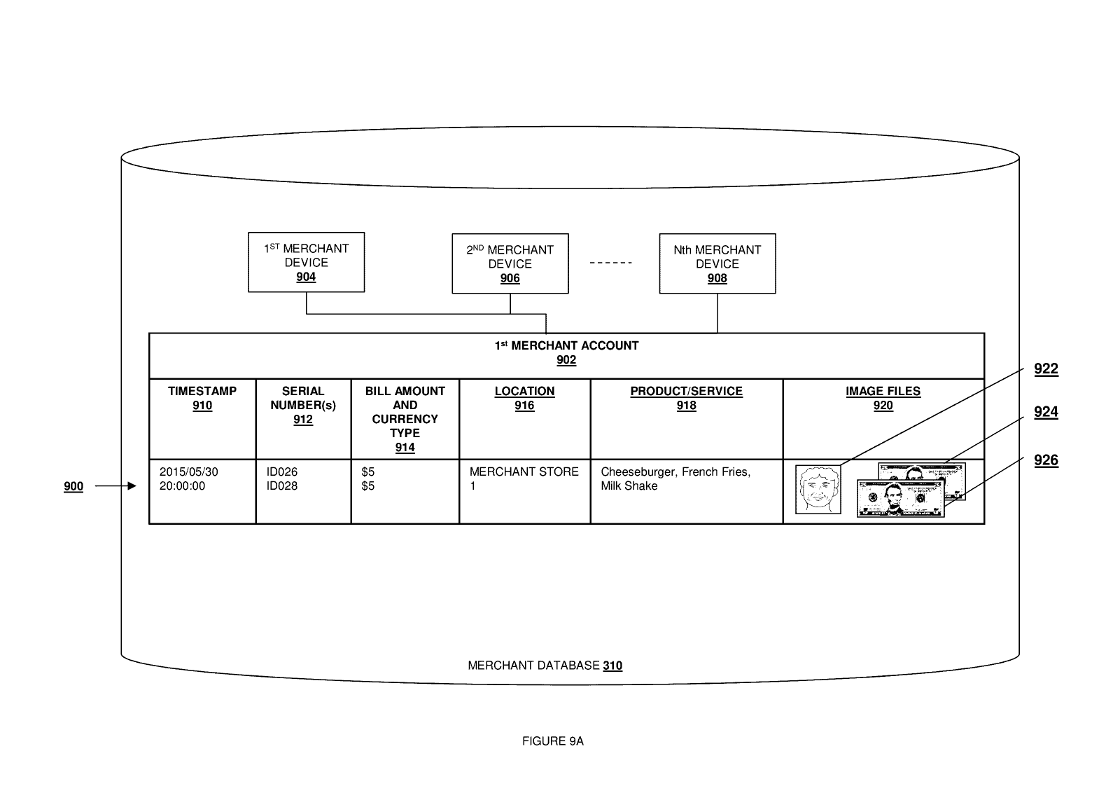

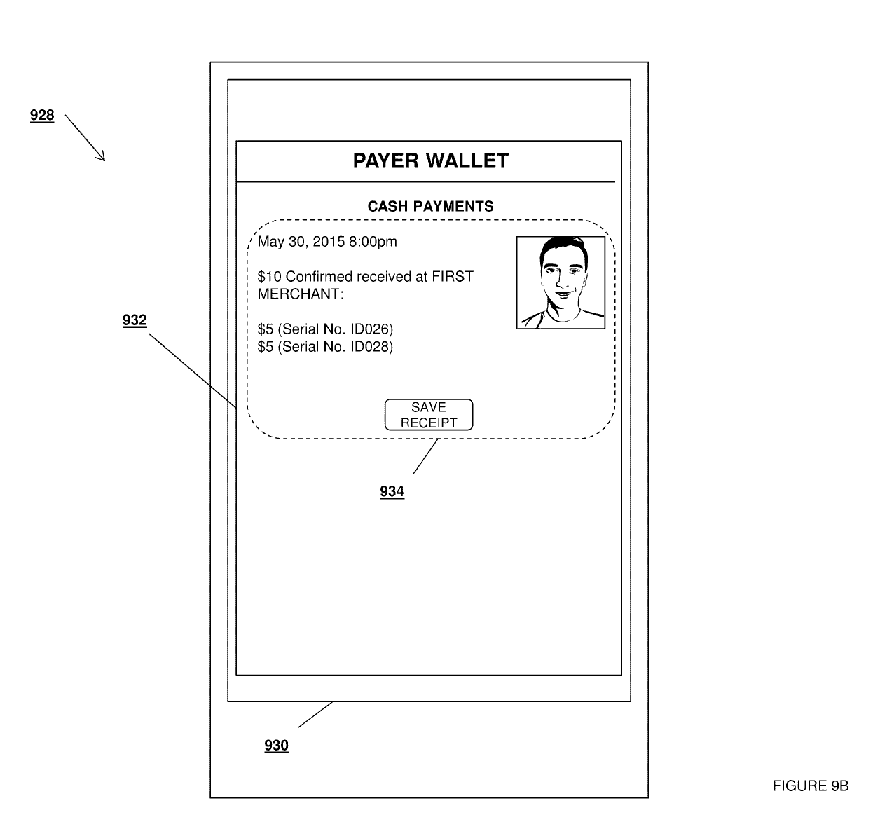

Referring back to FIG. 1, the method 100 then proceeds to decision block 110, where it is determined whether the second cash transfer information is received from a second payer device or a merchant device. In some embodiments, the payer device 206 and/or system provider device 304 may determine whether the second cash transfer information is received from a second payer device that is associated with a payer account, or from a merchant device associated with a merchant account, which will be discussed in detail below with reference to FIG. 9A. However, in some embodiments, decision block 110 may be indicative of different possible implementations of the method 100 (e.g., using cash transfer information captured from only payer device, or cash transfer information captured from payer devices and merchant devices). As such, decision block 110 may not actually be performed by the payer device and/or system provider device, but instead is simply provided to indicate that the method 100 operates differently when merchant devices are utilized to provide cash transfer information.

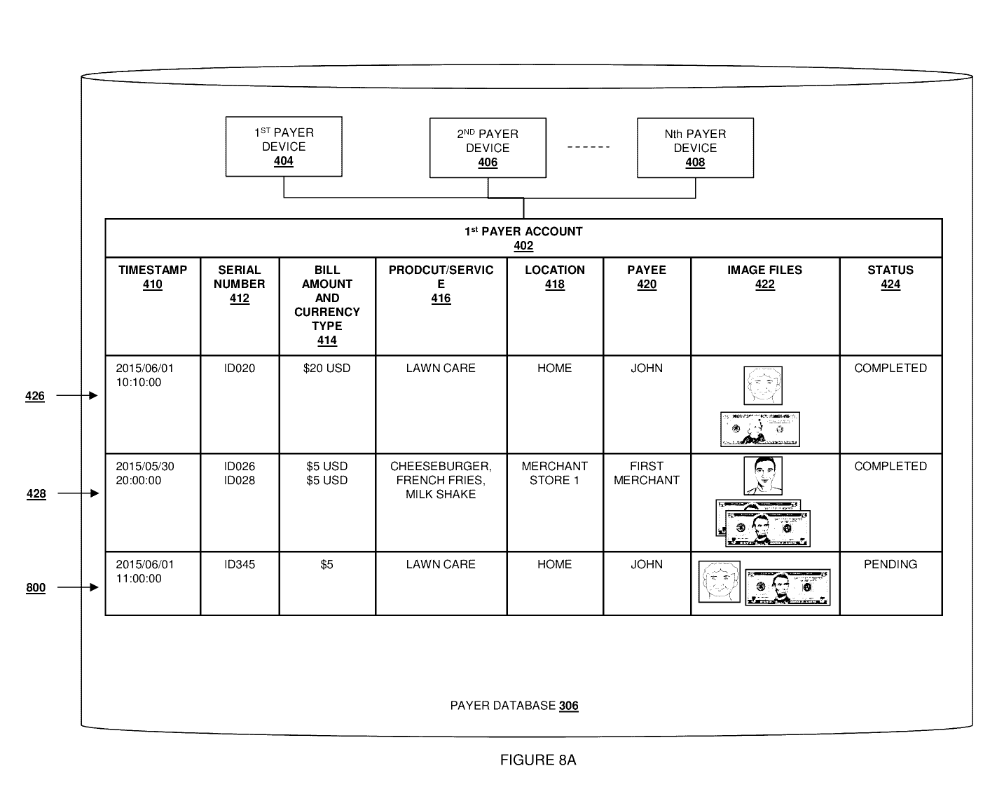

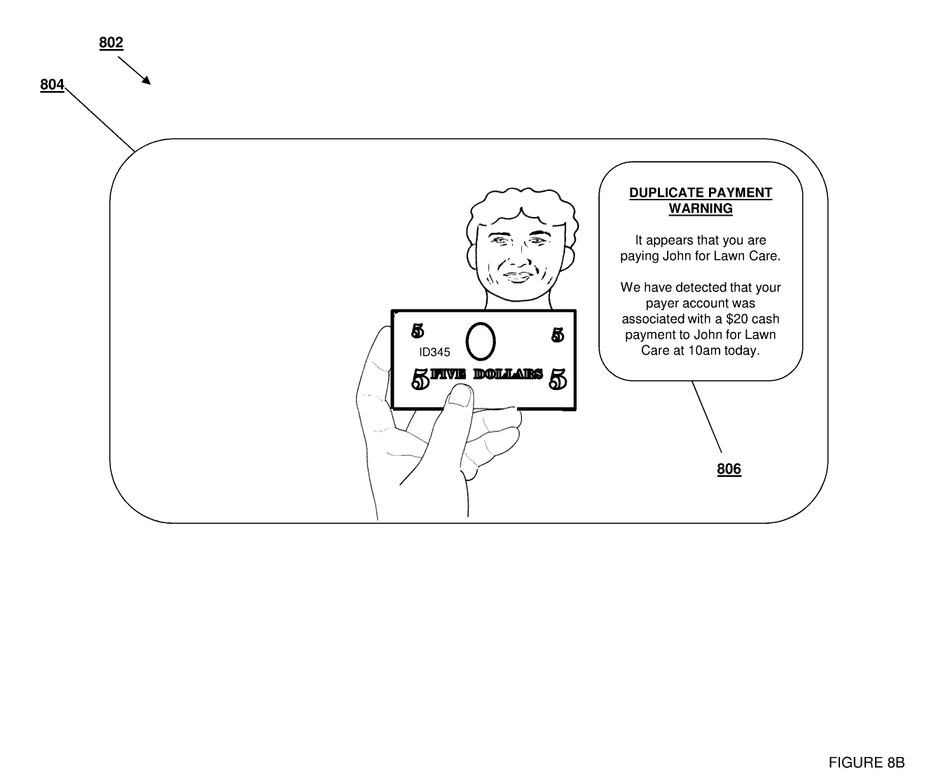

Referring to FIG. 1 and FIG. 8A, when the second cash transfer information is provided by a second payer device, the method 100 may proceed to block 112 where the second cash transfer information is associated with a payer account associated with the second payer device. FIG. 8A illustrates an embodiment cash transfer information 800 is associated with the first payer account 402 that associated with the second payer device 406/606 and that was also associated with the first payer device 206/404 as discussed above with reference to FIG. 4.

As illustrated in the example of FIG. 8A, cash transfer information 800 may be populated in a particular row of the first payer account 402. Similarly as discussed above with reference to the cash transactions 426 and 428, the particular row includes the time field 410 for the time of second cash transaction 600 (e.g., “2015/06/01 11:00:00”), the serial number field 412 for the serial number of the physical bill used in the second cash transaction 600 (e.g., “ID345”), the bill amount and currency type field 414 for the amount and currency type of the physical bill used in the second transaction 600 (e.g., “$5”), the product/service field 416 for product/service information of second cash transaction 600 (e.g., “LAWN CARE”), the location field 418 for the location of second cash transaction 600 (e.g., “HOME”), the payee field 420 for the payee information of the second cash transaction 600 (e.g., “JOHN”), the image files field 422 for the images captured in the second cash transaction 600 (e.g., the payee image and/or the physical bill image), and the status field 424 for second cash transaction 600 (e.g., “PENDING”). As discussed below, the cash transaction information 800 is illustrated and described above as providing a duplicate cash transaction (e.g., with respect to the cash transaction 426) and, in such embodiments, that cash transaction information 800 may not actually be associated with the first payer account 402, but instead may simply be used to determine the duplicate cash transaction. However, in other embodiments, the cash transaction 800 may not be a duplicate cash transaction, and may be associated with the first payer account 402 as illustrated in FIG. 8A.

Referring back to FIG. 1, the method 100 proceeds to block 114, where a duplicate payment is detected. In one embodiment, the payer device 606 and/or service provider device 304 may determine that the cash transaction information 800 provides a duplicate cash transaction with a common payee. For example, the service provider device 304 and/or the payer device 606 may reference the payer database 306 and determine that the first payer account 402 includes the cash transaction 426 that provides a cash transfer to a payee at a time that is the same payee and within a predetermined time period as the cash transaction 800. For example, duplicate payment criteria may require that the cash transfer information 426 and the cash transfer information 800 have the same payee information, the same location, the same product/service information, timing information within a predetermined time range, matching image files for a payee, etc. In a specific example, the duplicate payment criteria may require that cash transfer information 800 happened within a particular time period (e.g., one hour) after the previous duplicate payment. For further example, the particular time period may depend on the product/service information (e.g., one hour for lawn care, and two hours for house cleaning). For further example, the duplicate payment criteria may require that the previous duplicate payment has a status indicating that the corresponding cash transaction is completed.

In the embodiments illustrated in FIGS. 4 and 8A, the system provider device 304 and/or payer device 606 may determine that cash transfer information 800 of cash transaction 600 is a duplicate payment of cash transfer information 426 of cash transaction 200. In an embodiment, cash transfer information 800 meets the duplicate payment criteria by having the same product/service information (e.g., “LAWN CARE”), the same payee information (e.g., “JOHN”), the same location (e.g., “HOME”), times that are within a particular time period (e.g., “2015/06/01 11:00:00” is within one hour of “2015/06/01 10:10:00”), and/or a status (e.g., “COMPLETED”) indicating that cash transaction 200 was completed. It is noted that the examples of the duplicate payment criteria provided here are not limiting. The duplicate payment criteria may use any appropriate combination of the variety information provided in cash transfer information, and those criteria may be selected and/or combined depending on the level of duplicate payment detection desired (e.g., for higher amounts, fewer may be required.).

Referring now to FIGS. 1 and 8B, the method 100 proceeds to block 116, where a duplicate payment warning is provided to the second payer device. In one embodiment, the duplicate payment warning is provided to the second payer device before cash transaction 600 is completed. FIG. 8B illustrates an embodiment of a duplicate payment warning screen 804 that may be provided to the payer 602 on a wearable payer device 802. In the illustrated embodiment, the double payment warning screen 804 includes a warning message section 806 providing information of the previous duplicate payment. For example, the warning message section 806 includes the payee information (e.g., “John”), the product/service information (e.g., “lawn care”), the time (e.g., “10 am today”), and/or the amount and currency type (e.g., “$20”). However, the duplicate payment warning screen may be provided on other devices (e.g., a mobile phone), and may include other cash transfer information captured during the cash transaction 200 that is being duplicated (e.g., the image of the payee being paid, as captured during the cash transaction 200).

In some embodiments, the payer 602 may decide to continue the cash transaction 600, and after completing the cash transaction 600, the payer 602 may give the payer device 606 an indication (e.g., using audio description) that cash transaction 600 is completed. In response to receiving a status indication that the cash transaction 600 is completed, the status of cash transfer information 800 in the second payer account 404 of the payer database 306 may be updated (e.g., from “PENDING” to “COMPLETED”) to a status indicating that cash transaction 600 is completed. In some embodiments, the payer 602 may decide to cancel cash transaction 600 after receiving the duplicate payment warning, and the payer device 606 may receive a status indication (e.g., images that indicate that the cash transaction 600 is has been cancelled such as the cash not being handed to the payee, audio data from the payer 602 indicating that the cash transaction 600 has been cancelled, etc.). In response to receiving a status indication that cash transaction 600 is cancelled, the status of cash transfer information 800 in the second payer account 404 of the payer database 306 may be updated (e.g., from “PENDING” to “CANCELLED”) to a status indicating that cash transaction 600 was cancelled.

While cash transfer information for the duplicate payment is discussed above as being received from a different payer device from the payer device 206 in the cash transaction 200, in some embodiments, cash transfer information for the duplicate payment may be received from the same payer device as the payer device 206 of cash transaction 200 while remaining within the scope of the present disclosure.

Referring to FIGS. 1 and 9A, if at decision block 110 the second cash transfer information is provided by a merchant device, the method 100 proceeds to block 118 where the second cash transfer information is associated with a merchant account that is associated with the merchant device 712.

FIG. 9A illustrates an embodiment where cash transfer information 900 for the second cash transaction 700 is associated with a first merchant account 902 in the merchant database 310. In one embodiment, the service provider device 304 determines that the first merchant account 902 is associated with a first merchant device 904 (e.g., the merchant device 712 in FIG. 7A). For example, the service provider device 304 and/merchant device 904 may look up the first merchant account 902 in a database stored in the service provider device 304 or any other device on the network using an identifier of the merchant device 712 (e.g., MAC address, a merchant location, a merchant name, etc.). As illustrated, multiple merchant devices may be associated with the same merchant account 902. For example, multiple merchant devices at the same merchant location may be associated with the same merchant account 902. For further example, multiple merchant devices at different merchant locations of the same merchant may be associated with the same merchant account 902.

As illustrated in the example of FIG. 9A, a second merchant device 904, and up to an Nth merchant device 908 are associated with the first merchant account. One of skill in the art in possession of the present disclosure will recognize that the merchant database 310 may store any number of merchant accounts associated with any number of merchant devices while remaining within the scope of the present disclosure. In the illustrated embodiment, cash transfer information 900 for the second cash transaction 700 is populated in a particular row of the first merchant account 902. Similarly as discussed above, the particular row includes a time field 910 for the time of the second cash transaction 700 (e.g., “2015/05/30 20:00:00”), a serial number field 912 for the serial number of the physical bill(s) used in the second cash transaction 700 (e.g., “ID026 ID028”), the bill amount and currency type field 914 for the amount and currency type of the physical bill(s) captured during the second cash transaction 700 (e.g., “$5 $5”), a product/service field 916 for product/service information captured in the second cash transaction 700 (e.g., “CHEESEBURGER, FRENCH FRIES, MILK SHAKE”), a location field 918 for the location of the second cash transaction 700 (e.g., “MERCHANT STORE 1”), and an image files field 9202 for the images captured in the second cash transaction 700 (e.g., the cashier image 922 and/or the physical bill images 924 and 926).

The example illustrated in FIG. 9A is not intended to be limiting, and the first merchant account 902 may include columns for storing additional information received or determined during the second cash transaction 700. For example, the first merchant account 902 may include columns for storing the physical bill information discussed above for physical bills and/or coins that the payer 202 receives in change during cash transaction 700.

Referring to FIGS. 1, 3, 4, and 9A, the method 100 then proceeds to block 120 where a cash transfer information match is detected. In an embodiment, the system provider device 304 determines that cash transfer information 428 for cash transaction 700 received from the payer device 206 matches the cash transfer information 900 for cash transaction 700 received from the merchant device 712.

In one embodiment, the payer device 606 and the merchant device 712 may communicate, or the service provider device 304 may compare the payer database 306 and the merchant database 310, to determine that cash transfer information 428 matches the cash transfer information 900 using one or more cash transfer match criteria. In one example, the merchant cash transfer match criteria may require that a serial number of the cash transfer information 428 matches a serial number of the cash transfer information 900. In another example, the merchant cash transfer match criteria may require that all serial numbers of the cash transfer information 428 match the serial numbers of the cash transfer information 900. In some embodiments, additionally, the merchant cash transfer match criteria may further require that the cash transfer information 428 have a matching payee, time, location, product/service, and/or other proper as the cash transfer information 900. For further example, the merchant cash transfer match criteria may require that the cash transfer information 428 have a status indicating that that cash transaction is completed.

In the embodiments illustrated in FIGS. 4 and 9A, the system provider device 304 determines that cash transfer information 428 matches cash transfer information 900. In an embodiment, cash transfer information 428 meets the merchant cash transfer match criteria by including, for example, one or more serial numbers of physical bills (e.g., “ID026” and/or “ID028”) that match the one or more serial numbers of cash transfer information 900, the same product/service information, the same location, the same time, a payee (e.g., “FIRST MERCHANT”) that matches the merchant account of cash transfer information 900, and/or a status (e.g., “COMPLETED”) indicating that the corresponding cash transaction is completed. It is noted that the examples of merchant cash transfer match criteria provided here are not meant to be limiting, and the merchant cash transfer match criteria may use any appropriate combination of the variety information provided in cash transfer information to detect a matching cash transaction.

Referring now to FIGS. 1 and 9B, the method 100 proceeds to block 124 where a cash transfer information match is provided to a first payer device. Referring now to FIG. 9B, an embodiment of a payer device 928 is illustrated to provide examples of a merchant cash transaction confirmation screen that is communicated to the first payer device. As illustrated in FIG. 9B, the payer device 928 includes a display 930 displaying a merchant cash transaction confirmation screen 932 that includes a receipt section 934 that provides a receipt of the second cash transaction 700, including the time of the second cash transaction 700 (e.g. “May 30, 2015 8:00 pm), the payee information for the second cash transaction 700 (e.g., “FIRST MERCHANT”), the amount and currency used in the second cash transaction 700 (e.g., “$5” and “$5”) and the serial numbers (“ID026” and “ID028”) of the physical bill information captured in the second cash transaction 700, and the image files captured in the second cash transaction 700 (e.g., the cashier image 922). Using the specific example of the communication illustrated in FIG. 9B, if the payer 202 would like to save the receipt (e.g., on the payer device 928, on the system provider device 304, or any other device), the payer 202 may select the “SAVE RECEIPT” choice in the receipt section 934.

As such, when the same or similar cash transfer information is captured by both the payer device and the merchant device, that cash transfer information may be determined to match in one or more ways, and in response to determining the match, a confirmed cash transaction may be identified. The confirmed cash transaction may include the detection of the same physical bills be provided by the payer and received by the merchant, and may allow cash transfer information stored for the cash transaction in the payer database and/or merchant database to be supplemented. For example, the payer device may provide cash transfer information not known to the merchant device, and the merchant device may provide cash transfer information not known to the payer device, and thus the payer account and merchant accounts updated with the cash transfer information may be supplemented with information that would otherwise not be available. In addition, the detection of matching cash transfer information at the merchant device may indicate the status of the cash transaction (e.g., completed), and provide for the delivery of the receipt to the payer as discussed above.

In some embodiments, the payer device 928 may be a variety of devices that the payer 202 of cash the second transaction 700 uses. For example, the payer device 928 may be the payer device 206 used by the payer 202 during the second cash transaction 700. However, in other examples, the payer device 928 may be a device that is different from the payer device 206 used by the payer 202 during the second cash transaction 700 (e.g., a mobile phone rather than the wearable device that was used during the cash transaction).

The example illustrated in FIG. 9B is not intended to be limiting, and the merchant cash transaction confirmation screen provided by the payer device 928 may be provided in a variety of manners (through an application, as a message (e.g., an email, a text message, a picture message, a “pop-up”, a voice call, etc.) without departing from the scope of the present disclosure.

As discussed above, while a few examples of the determination, detection, and use of cash transfer information have been provided above, any cash transfer information associated with cash transactions may be determined, detected, and used in any configuration or order while remaining within the scope of the present disclosure. Thus, while the cash transfer information and other information has been illustrated as being used to determine, detect, and use the physical bill information of physical bills used in the cash transaction, the payee information, the product/service information, the time and location information, image files related to the cash transactions, and status of the cash transactions, any presentation and/or ordering of the cash transfer information and other information discussed above is envisioned as falling within the scope of the present disclosure. Furthermore, the payer or merchant may be able to configure the presentation and/or ordering of presentation of the cash transfer information by a cash information application on the payer device in any order to provide the cash transfer information as desired.

Thus, systems and methods for providing cash transaction tracking have been described that allow payers and merchants to track and manage cash transactions. Payer devices and merchant devices capture and provide cash transfer information including a variety of information related to cash transactions, including physical bill information and payee information. In one embodiment, at some point before a cash transaction is completed, that cash transaction may be detected as a duplicate cash transaction and a duplicate payment warning message may be provided to the payer. In another embodiment, after a cash transaction is completed, cash transfer information in a merchant account may be determined to match cash transfer information in a payer account, and in response a receipt for the cash transaction may automatically be provided to the payer without any manual entry of additional information. Such systems and methods may provide for decreased double payment risk, lower transaction costs, a more comprehensive picture of the cash flow, and/or a variety of other benefits that have not been previously available with regard to cash transactions.

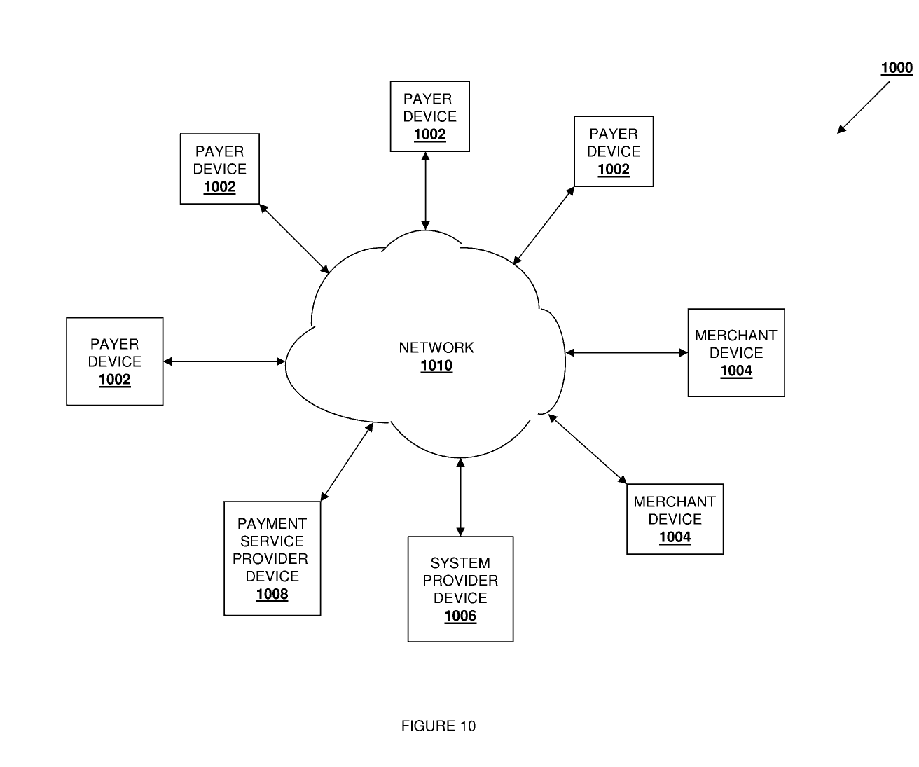

Referring now to FIG. 10, an embodiment of a network-based system 1000 for implementing one or more processes described herein is illustrated. As shown, network-based system 1000 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 6 may be deployed in other ways and that the operations performed and/or the services provided by such servers may be combined or separated for a given implementation and may be performed by a greater number or fewer number of servers. One or more servers may be operated and/or maintained by the same or different entities.

The embodiment of the networked system 1000 illustrated in FIG. 10 includes a plurality of payer devices 1002, a plurality of merchant devices 1004, a system provider device 1006, and a payment service provider device 1008 in communication over a network 1010. Any of the payer devices 1002 may be the payer devices 206, 220, and 706, discussed above. The merchant devices 1004 may be the merchant devices 712 discussed above and may be operated by the cashier 714 discussed above. The system provider device 1006 may be the system provider device 304 discussed above and may be operated by a system provider such as, for example, PayPal Inc. of San Jose, Calif.

The payer devices 1002, merchant devices 1004, and system provider device 1006 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 1000, and/or accessible over the network 1010.

The network 1010 may be implemented as a single network or a combination of multiple networks. For example, in various embodiments, the network 1010 may include the Internet and/or one or more intranets, landline networks, wireless networks, and/or other appropriate types of networks.

The payer device 1002 may be implemented using any appropriate combination of hardware and/or software configured for wired and/or wireless communication over network 1010. For example, in one embodiment, the payer device 1002 may be implemented as a personal computer of a user in communication with the Internet. In some embodiments, the payer device 1002 may be a wearable device. In some embodiments, the payer device 1002 may be a smart phone, personal digital assistant (PDA), laptop computer, and/or other types of computing devices.

The payer device 1002 may include one or more browser applications which may be used, for example, to provide a convenient interface to permit the payer to browse information available over the network 1010. For example, in one embodiment, the browser application may be implemented as a web browser configured to view information available over the Internet.

The payer device 1002 may also include one or more toolbar applications which may be used, for example, to provide user-side processing for performing desired tasks in response to operations selected by the payer. In one embodiment, the toolbar application may display a user interface in connection with the browser application.

The payer device 1002 may further include other applications as may be desired in particular embodiments to provide desired features to the payer device 1002. In particular, the other applications may include a payment application for payments assisted by a payment service provider through the payment service provider device 1008. The other applications may also include security applications for implementing user-side security features, programmatic user applications for interfacing with appropriate application programming interfaces (APIs) over the network 1010, or other types of applications. Email and/or text applications may also be included, which allow the payer to send and receive emails and/or text messages through the network 110. The payer device 1002 includes one or more user and/or device identifiers which may be implemented, for example, as operating system registry entries, cookies associated with the browser application, identifiers associated with hardware of the payer device 1002, or other appropriate identifiers, such as a phone number. In one embodiment, the user identifier may be used by the system provider device 1006 and/or payment service provider device 1008 to associate the user with a particular account as further described herein.

The merchant device 1004 may be maintained, for example, by a conventional or on-line merchant, conventional or digital goods seller, individual seller, and/or application developer offering various products and/or services in exchange for payment to be received conventionally or over the network 1010. In this regard, the merchant device 1004 may include a database identifying available products and/or services (e.g., collectively referred to as items) which may be made available for viewing and purchase by the payer.

The merchant device 1004 also includes a checkout application which may be configured to facilitate the purchase by the payer of items. The checkout application may be configured to accept payment information from the user through the payer device 1002, the system provider through the system provider device 1006, and/or from the payment service provider through the payment service provider device 1008 over the network 1010.

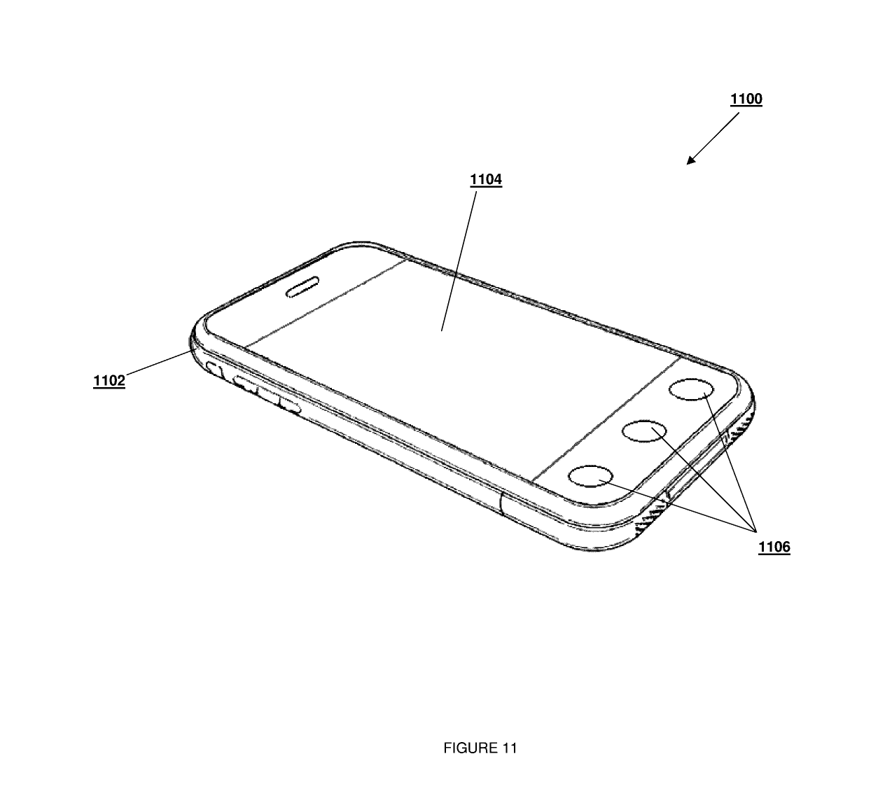

Referring now to FIG. 11, an embodiment of a payer device 1100 is illustrated. The payer device 1100 may be the payer devices 200 and/or 602. The payer device 1100 includes a chassis 1102 having a display 1104 and an input device including the display 1104 and a plurality of input buttons 1106. One of skill in the art will recognize that the payer device 1100 is a portable or mobile phone including a touch screen input device and a plurality of input buttons that allow the functionality discussed above with reference to the method 100. However, a variety of other portable/mobile payer devices and/or desktop payer devices may be used in the method 100 without departing from the scope of the present disclosure.

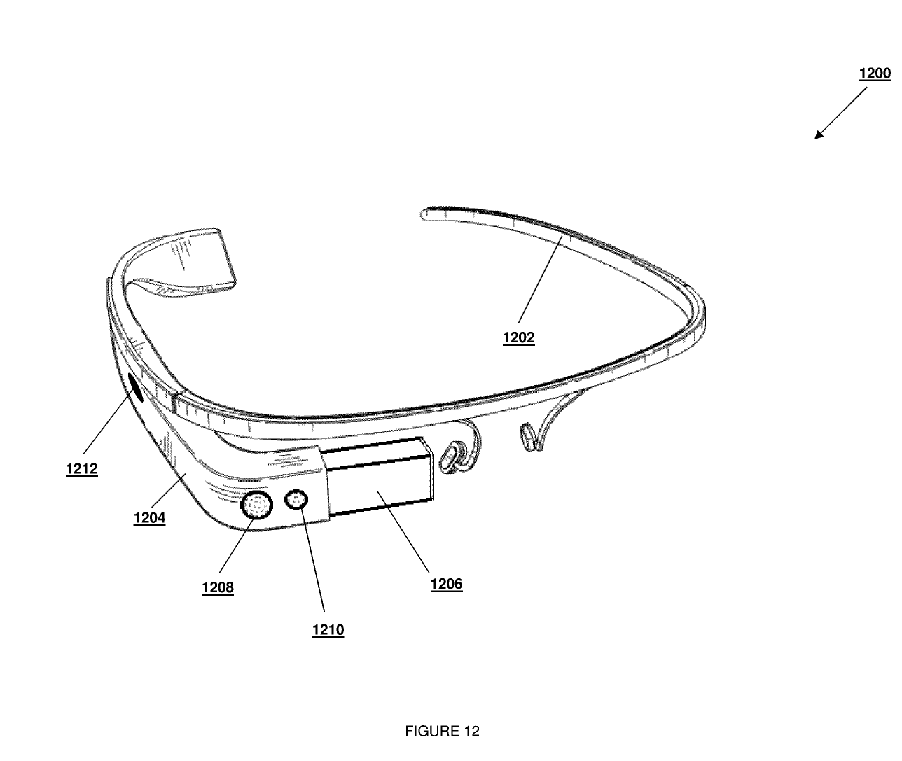

Referring now to FIG. 12, an embodiment of a wearable payer device 1200 is illustrated. The wearable payer device 1200 may be the may be the wearable payer devices, discussed above. The wearable payer device 1200 includes a frame 1202 having a computing chassis 1204 that extends from the frame 1202, a display device 1206 that extends from the computing chassis 1204, a microphone 1208 located on the computing chassis 1204, a camera 1210 located on the computing chassis 1204, and a speaker 1212 located on the computing chassis 1204. One of skill in the art will recognize that the wearable payer device 1200 is a mobile wearable device such as, for example, Google Glass® available from Google Inc. of Mountain View, Calif. that may provide a user with the functionality discussed above with reference to the methods discussed above. However, a variety of other mobile wearable devices may be used in the methods discussed above without departing from the scope of the present disclosure.

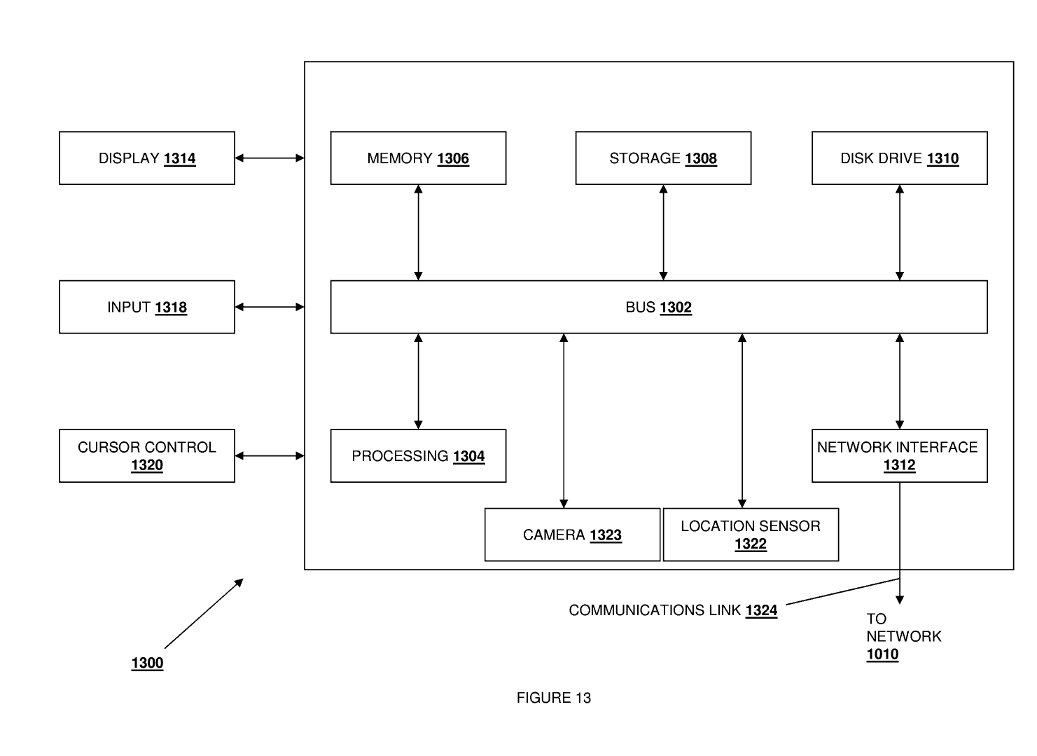

Referring now to FIG. 13, an embodiment of a computer system 1300 suitable for implementing, for example, the payer devices 206, 220, and 706, merchant device 712, and/or system provider device 304, is illustrated. It should be appreciated that other devices utilized by payers, merchants, and/or system providers in the system discussed above may be implemented as the computer system 1300 in a manner as follows.

In accordance with various embodiments of the present disclosure, computer system 1300, such as a computer and/or a network server, includes a bus 1302 or other communication mechanism for communicating information, which interconnects subsystems and components, such as a processing component 1304 (e.g., processor, micro-controller, digital signal processor (DSP), etc.), a system memory component 1306 (e.g., RAM), a static storage component 1308 (e.g., ROM), a disk drive component 1310 (e.g., magnetic or optical), a network interface component 1312 (e.g., modem or Ethernet card), a display component 1314 (e.g., CRT or LCD), an input component 1318 (e.g., keyboard, keypad, or virtual keyboard), a cursor control component 1320 (e.g., mouse, pointer, or trackball), a location determination component 1322 (e.g., a Global Positioning System (GPS) device as illustrated, a cell tower triangulation device, and/or a variety of other location determination devices known in the art.), and/or a camera component 1023. In one implementation, the disk drive component 1310 may comprise a database having one or more disk drive components.

In accordance with embodiments of the present disclosure, the computer system 1300 performs specific operations by the processor 1304 executing one or more sequences of instructions contained in the memory component 1306, such as described herein with respect to the payer device(s) 206, 220, 706, the merchant device(s) 712, and/or the system provider device(s) 304. Such instructions may be read into the system memory component 1306 from another computer readable medium, such as the static storage component 1308 or the disk drive component 1310. In other embodiments, hard-wired circuitry may be used in place of or in combination with software instructions to implement the present disclosure.

Logic may be encoded in a computer readable medium, which may refer to any medium that participates in providing instructions to the processor 1304 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 1310, volatile media includes dynamic memory, such as the system memory component 1306, and transmission media includes coaxial cables, copper wire, and fiber optics, including wires that comprise the bus 1302. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the present disclosure, execution of instruction sequences to practice the present disclosure may be performed by the computer system 1300. In various other embodiments of the present disclosure, a plurality of the computer systems 1300 coupled by a communication link 1324 to the network 1010 (e.g., such as a LAN, WLAN, PTSN, and/or various other wired or wireless networks, including telecommunications, mobile, and cellular phone networks) may perform instruction sequences to practice the present disclosure in coordination with one another.

The computer system 1300 may transmit and receive messages, data, information and instructions, including one or more programs (i.e., application code) through the communication link 1324 and the network interface component 1312. The network interface component 1312 may include an antenna, either separate or integrated, to enable transmission and reception via the communication link 1324. Received program code may be executed by processor 1304 as received and/or stored in disk drive component 1310 or some other non-volatile storage component for execution.

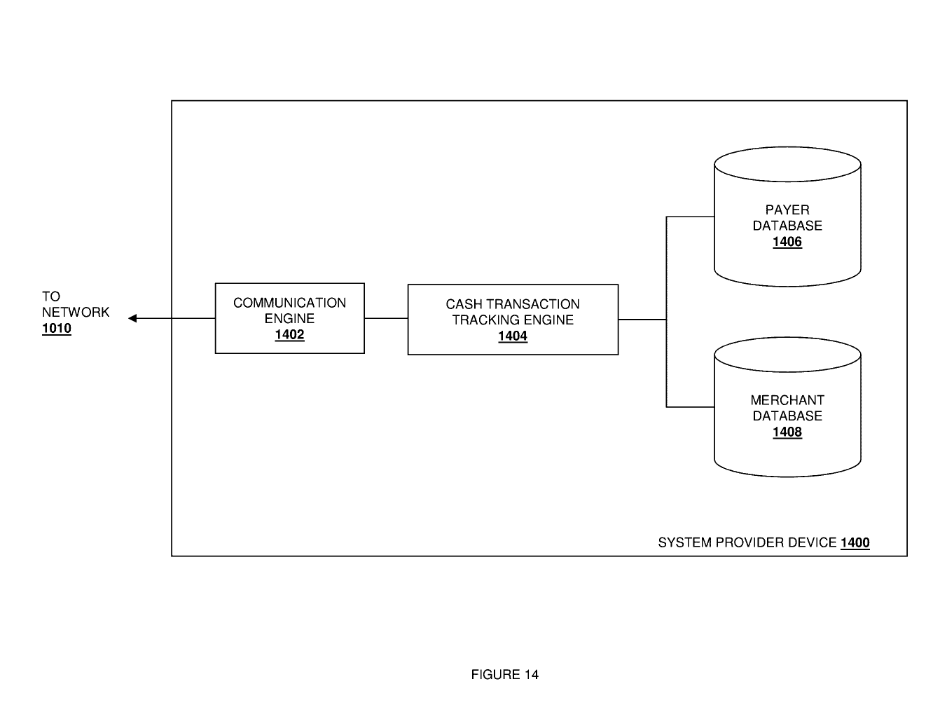

Referring now to FIG. 14, an embodiment of a system provider device 1400 is illustrated. In an embodiment, the system provider device 1400 may be the system provider devices discussed above. The system provider device 1400 includes a communication engine 1402 that is coupled to the network 1010 and to a cash transaction tracking engine 1404 that is coupled to a payer database 1406 and a merchant database 1408. The communication engine 1402 may be software or instructions stored on a computer-readable medium that allows the device 1400 to send and receive information over the network 1010. The cash transaction tracking engine 1404 may be software or instructions stored on a computer-readable medium that is operable to receive cash transfer information and associate it with payers accounts in the payer database 1406, determine whether cash transfer information received from multiple devices are associated with each other, send a cash transfer association message to at least one of the multiple devices, and provide any of the other functionality that is discussed above. While the databases 1406 and 1408 have been illustrated as located in the system provider device 1400, one of skill in the art will recognize that it may be connected to the cash transaction tracking engine 1404 through the network 1010 without departing from the scope of the present disclosure.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on payees and payers; however, a payer or consumer can pay, or otherwise interact with any type of recipient, including charities and individuals. The payment does not have to involve a purchase, but may be a loan, a charitable contribution, a gift, etc. Thus, payee as used herein can also include charities, individuals, and any other entity or person receiving a payment from a payer. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A physical bill tracking and alert system, comprising:
a non-transitory memory storing first payer account information associated with a first payer device; and
one or more hardware processors coupled to the memory and configured to read instructions from the memory to perform the steps of:
receiving first cash transfer information that includes at least one first identifier associated with at least one first physical bill from the first payer device;
associating the first cash transfer information with the first payer account information in the non-transitory memory;
receiving second cash transfer information from a second device that is different than the first payer device; and
determining that the second cash transfer information is associated with the first cash transfer information and, in response, sending a cash transaction association message to at least one of the first payer device and the second device.

2. The system of claim 1, wherein the second device is a second payer device that is associated with the first payer account information in the non-transitory memory, and wherein the one or more hardware processors are operable to read instructions from the memory to perform the steps of:
determining that the second cash transfer information is associated with the first cash transfer information based on both the first cash transfer information and the second cash transfer information having the same recipient, wherein the cash transfer association message is sent to the second payer device and includes a duplicate payment warning.

3. The system of claim 1, wherein the second device is a merchant device, and wherein the one or more processors are operable to read instructions from the memory to perform the steps of:
determining that the second cash transfer information is associated with the first cash transfer information based on the at least one first identifier associated with at least one first physical bill matching at least one second identifier associated with at least one second physical bill that is included in the second cash transfer information, wherein the cash transfer association message is sent to the first payer device and includes a physical bill identifier match message.

4. The system of claim 1, wherein the at least one first identifier includes a serial number of the at least one first physical bill.

5. The system of claim 1, wherein the first cash transfer information includes details that include at least one of a payee, a product, a service, and a captured image, and wherein at least one of the payee, a product, and a service is provided by voice.

6. The system of claim 1, wherein the first payer device is a wearable first payer device that is configured to capture the at least one first identifier associated with at least one first physical bill.

7. A method for tracking physical bills and providing alerts related to the tracking, comprising:
storing in a database first payer account information associated with a first payer device;
receiving first cash transfer information that includes at least one first identifier associated with at least one first physical bill from the first payer device;
associating the first cash transfer information with the first payer account information in the database;
receiving second cash transfer information from a second device that is different than the first payer device; and
determining that the second cash transfer information is associated with the first cash transfer information and, in response, sending a cash transaction association message to at least one of the first payer device and the second device.

8. The method of claim 7, further comprising:
determining that the second device is a second payer device that is associated with the first payer account information in the database and, in response, determining that the second cash transfer information is associated with the first cash transfer information based on duplicate payment conditions including both the first cash transfer information and the second cash transfer information having the same payee, wherein the cash transfer association message is sent to the second payer device and includes a duplicate payment warning.

9. The method of claim 8, wherein the duplicate payment conditions further include both the first cash transfer information and the second cash transfer information having the same location.

10. The method of claim 7, further comprising:
determining that the second device is a merchant device and, in response, determining that the second cash transfer information is associated with the first cash transfer information based on the at least one first identifier associated with at least one first physical bill matching at least one second identifier associated with at least one second physical bill that is included in the second cash transfer information, wherein the cash transfer association message is sent to the first payer device and includes a physical bill identifier match message.

11. The method of claim 7, wherein the at least one first identifier includes a serial number of the at least one first physical bill.

12. The method of claim 7, wherein the first cash transfer information includes voice-provided payment details that include at least one of a payee, a product, a service, and a captured image.

13. The method of claim 7, wherein the first payer device is a wearable first payer device that is configured to capture the at least one first identifier associated with at least one first physical bill.

14. A non-transitory computer-readable medium comprising instructions which, in response to execution by a computer system, cause the computer system to perform a method comprising:
storing first payer account information associated with a first payer device;
receiving first cash transfer information that includes at least one first identifier associated with at least one first physical bill from the first payer device;
associating the first cash transfer information with the first payer account information;
receiving second cash transfer information from a second device that is different than the first payer device; and
determining that the second cash transfer information is associated with the first cash transfer information and, in response, sending a cash transaction association message to at least one of the first payer device and the second device.

15. The non-transitory machine-readable medium of claim 14, wherein the method further comprises:
determining that the second device is a second payer device that is associated with the first payer account information in the database and, in response, determining that the second cash transfer information is associated with the first cash transfer information based on duplicate payment conditions including both the first cash transfer information and the second cash transfer information having the same payee, wherein the cash transfer association message is sent to the second payer device and includes a duplicate payment warning.

16. The method of claim 15, wherein the duplicate payment conditions further include both the first cash transfer information and the second cash transfer information having the same location.

17. The non-transitory machine-readable medium of claim 14, wherein the method further comprises:
determining that the second device is a merchant device and, in response, determining that the second cash transfer information is associated with the first cash transfer information based on the at least one first identifier associated with at least one first physical bill matching at least one second identifier associated with at least one second physical bill that is included in the second cash transfer information, wherein the cash transfer association message is sent to the first payer device and includes a physical bill identifier match message.

18. The non-transitory machine-readable medium of claim 14, wherein the at least one first identifier includes a serial number of the at least one first physical bill.

19. The non-transitory machine-readable medium of claim 14, wherein the first cash transfer information includes voice-provided payment details that include at least one of a payee, a product, a service, and a captured image.

20. The method of claim 14, wherein the first payer device is a wearable first payer device that is configured to capture the at least one first identifier associated with at least one first physical bill.
